(19) United States
(12) Patent Application Publication
(10) Pub. No.: US 2026/0087445 A1
(43) Pub. Date: Mar. 26, 2026

(54) PROBABILISTIC EVENT TRIGGERING USING LOCATION DATA

(71) Applicant: Radius Networks, Inc., Washington, DC (US)

(72) Inventors: Timothy Judkins, Vienna, VA (US); James Nebeker, Catonsville, MD (US); Christopher Sexton, McLean, VA (US); Kristoffer Zabala, Springfield, VA (US); Cora Leech, River Forest, IL (US); Aaron Hill, Ithaca, NY (US)

(73) Assignee: Radius Networks, Inc., Washington, DC (US)

(21) Appl. No.: 19/398,759

(22) Filed: Nov. 24, 2025

Related U.S. Application Data
(63) Continuation-in-part of application No. 18/497,486, filed on Oct. 30, 2023, now Pat. No. 12,505,405.

(51) Int. Cl. G06Q 10/0836; G01C 21/00; G06Q 10/0833; G06T 5/70

(52) U.S. Cl. CPC G06Q 10/0836; G01C 21/3837; G06Q 10/0833; G06T 5/70

(57) ABSTRACT

Techniques for determining an estimated time of arrival at a pickup location are discussed herein. For example, techniques may include receiving first location data from a user computing device approaching a pickup location, receiving data indicating when the device entered a virtual boundary associated with the pickup location, determining a location of the device when it was a particular time period away from entering the virtual boundary, associating the location with a discretized location of a map, applying a blurring function to generate a probability field indicating probability of entering the virtual boundary within the time period, using the probability field to determine probability of arriving at the pickup location within the particular time period, and triggering an action based on the probability meeting a threshold.

### RELATED APPLICATION

This application is a continuation-in-part of and claims the benefit of priority to U.S. patent application Ser. No. 18/497,486, filed Oct. 30, 2023, which is incorporated herein by reference in its entirety and for all purposes.

### BACKGROUND

Restaurants, grocery stores, and retail stores often process hundreds of pickup orders on a daily basis. Regardless of by who picks up the item (e.g., delivery driver, customer, robot) or where the pickup occurs (e.g., in-store, drive-thru, curbside), retail store staff like to know the exact estimated time of arrival (“ETA”) for a pickup. Even with an assigned ready or pickup time, unanticipated events, such as traffic, parking lot congestion, and the number of patrons, can produce an early, late, or even canceled pickup. Though a variety of techniques exist for generating ETAs, the inaccuracy and the inability of those techniques to consider a variety of metrics still leave much to be desired for an efficient, effective, and accurate technique for calculating and reporting ETAs.

Traditional ETA calculation systems typically rely on basic mapping services and routing algorithms that consider factors such as distance, road conditions, and general traffic patterns. These conventional approaches often utilize third-party mapping providers that calculate arrival times based on routing to a single point location, such as a pin dropped at a business address. While such systems may provide reasonable accuracy for longer-distance travel, they tend to exhibit larger margins of error as customers approach their final destination.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example environment including one or more stores, managing computing device(s), and user device(s), in accordance with examples of the disclosure.

FIG. 2 illustrates an example environment that is usable to implement the techniques and systems described herein.

FIG. 3 illustrates another example environment that is usable to implement the techniques and systems described herein.

FIG. 4 illustrates an example process for generating ETAs of customers picking up orders in accordance with examples of the disclosure.

FIG. 5A illustrates an example process for associating location data with a discretized location of a map, in accordance with examples of the disclosure.

FIG. 5B illustrates an example process for generating probability fields from aggregated location data, in accordance with examples of the disclosure.

FIG. 6 illustrates an example process for event triggering using probabilistic location data, in accordance with examples of the disclosure.

FIG. 7 illustrates an example process for event triggering using state-dependent probability fields, in accordance with examples of the disclosure.

FIG. 8 illustrates an example process for probabilistic event triggering based on location data and virtual boundaries, in accordance with examples of the disclosure.

### DETAILED DESCRIPTION

As discussed above, knowing the precise time of a customer's arrival is increasingly becoming a desired and even necessary component of an efficient and effective business. Inaccuracies in reported ETAs may lead to logistical issues (e.g., improper management of order queues), increased waste (e.g., remakes) unsatisfied customers (e.g., extended waits for an order), inefficient staff (e.g., idling), and ultimately lost revenues for the business (e.g., cancelled orders). For example, if a restaurant purports to provide the freshest food, inaccurate ETAs can hinder the ability of staff to appropriately meet the guarantees it ensures to its customers. These inaccuracies may lead to logistical problems for staff, such as beginning an order's cooking process too early or too late, and may negatively influence customer expectations and experiences, such as expecting an order to be hot at pickup. In some cases, ineffective business operations due to the inaccurate management of pickup orders may lead to a negative perception and ultimately hinder the financial growth of businesses.

As previously mentioned, there are many previous attempts at producing ETAs. However, these conventional systems and methods often only take into consideration basic road maps and already calculated metrics, such as distance and direction, and do not take into account metrics such as current traffic, parking lot congestion, and business popularity, to name a few nonlimiting examples. While current systems and methods for calculating ETAs may be accurate over larger distances, as the margin of error is smaller and that potential error is overall less statistically impactful, the closer the customer is to the business, the greater the impacts and potential harms of an inaccurate ETA may be. For example, if a restaurant, located in a congested shopping center, knows that it needs to begin the customer's food preparation when they are five minutes away from the business, even an inaccuracy of one minute may severely impact the logistics and overall satisfaction of an order. A one-minute error in a reported ETA of thirty minutes is far less statistically significant when compared to a one-minute error in a reported ETA of four minutes. Because current ETA producing systems and methods do not consider metrics such as parking lot congestion and business popularity, these metrics, among others, may severely impact a patron's actual time of arrival when not considered in the calculation of that patron's ETA.

By applying machine learning models and methodologies using a deep neutral network of known behaviors and incoming data, the system processes, calculates, evaluates, and updates the presented ETAs to best inform all involved parties of a patron's status. Thus, the systems and methods described herein relate to utilizing machine-learning models to accurately calculating the arrival status of a customer to optimize the pickup and delivery of goods and services.

The techniques described herein are environment-friendly. For example, in the food industry, freshness may be important, and pickup orders prepared over a predetermined time will be thrown away if the customer who places the order does not arrive at an expected time. By monitoring the customer/pickup entity's location, systems and methods discussed here can reduce food waste significantly. Thus, the cost of running stores may be saved. Moreover, the staff efficiency associated with stores can be improved because the system can allow staff to prepare orders for customers knowing a precise time that the customer will arrive. Further, the user satisfaction can be improved.

The techniques described herein may improve the functioning of a computing device by providing a robust method of determining an estimated time of arrival. In some examples, the techniques can reduce overall processing by refraining from inputting data to a model before the distance between a user computing device and destination is below a threshold distance. Further, as the model may determine a more accurate estimated time of arrival relative to techniques not using the model, an updated estimated time of arrival may be determined less frequently than other techniques. Additional, subsequent actions such as beginning to prepare a good and/or service can be initiated more accurately, which can result in conserving downstream processing and operations. These and other improvements to the functioning of the computer are discussed herein.

The techniques described herein may be implemented in a number of ways. Example implementations are provided below with reference to the following figures. Although discussed in the context of food pickup scenarios, the methods, apparatuses, and systems described herein may be applied to a variety of scenarios (e.g., grocery pickup scenarios, pharmacy pickup scenarios, package drop-off scenarios, car rental scenarios, third-party delivery scenarios, providing any good or service, etc.), and are not limited to food pickup scenarios. In some instances, the techniques may be utilized in a drive-through pickup context, a curbside pickup context, an in-store pickup context, or the like.

As discussed above, conventional ETA prediction systems face significant challenges in providing accurate arrival time estimates, particularly for the final stages of a customer's journey to a pickup location. These systems typically rely on basic mapping services that route to single point locations and fail to account for site-specific factors such as multiple entrance points, parking availability, and contextual variables like time of day or weather conditions, resulting in substantial margins of error that can severely impact business operations and customer satisfaction.

This application relates to techniques for probabilistic event triggering using historical location data to create spatial probability fields that accurately predict customer arrival times at pickup locations. The system processes historical customer location data into a discretized grid, applies filtering functions such as Gaussian blur to generate smooth probability distributions, and uses these probability fields to determine the likelihood of a customer being within a specified time threshold of a site based on their current location. Unlike conventional ETA systems that rely on basic mapping services and route to single point locations, the disclosed probabilistic event triggering (PET) system accounts for multiple entrance points, site-specific factors, and contextual variables to achieve significantly improved accuracy in arrival time predictions, enabling businesses to trigger preparation activities and other actions with precision timing that reduces waste, improves operational efficiency, and enhances customer satisfaction.

In some instances, the disclosed techniques include a method for probabilistic event triggering that receives first location data from a user computing device, where the first location data represents locations of the user computing device as it approaches a pickup location. The method further receives data indicating when the user computing device entered a virtual boundary associated with the pickup location, which may be defined as a geofence or polygonal area surrounding the premises or specific pickup zones such as drive-through entrances, curbside parking areas, or store parking lots. Based on the first location data, the method determines a location of the user computing device when the user computing device was a particular time period away from entering the virtual boundary, such as 60 seconds or another configurable time threshold that corresponds to the desired trigger timing for preparation activities.

In some examples, the method associates the determined location with a discretized location of a map of an environment proximate the pickup location, where the map is subdivided into a configurable grid system, such as 5-meter grid cells, with each grid cell or pixel representing a discrete spatial unit for probability analysis. The method applies a blurring function, such as a Gaussian blur function, to the map to generate a probability field, where a probability of the probability field indicates a probability of a computing device at a particular location entering the virtual boundary within the particular time period. This blurring function smooths the discrete location data points to create a continuous probability distribution that accounts for spatial uncertainty and generalizes the historical arrival patterns to nearby locations.

In some instances, the method uses the probability field to determine a probability of arriving at the pickup location within the particular time period and triggers an action at the pickup location based on the probability meeting or exceeding a threshold probability. The triggered actions may include preparing an order, notifying staff, preparing parking areas, sending notifications to customers or staff, or updating order status information. The probability field for the pickup location may be generated based on time of arrival data associated with the pickup location, incorporating historical patterns of customer arrivals and movement through the surrounding area.

In some examples, the method receives additional location data representing additional locations and arrival times of other user computing devices associated with the pickup location and generates an updated probability field based at least in part on the existing probability field, the additional location data, and a Bayesian algorithm. This Bayesian approach enables continuous learning and adaptation of the probability model, where new data is incorporated to refine the accuracy of the probability field while maintaining the accumulated knowledge from historical observations. The probability field may be one of a plurality of probability fields, where the specific probability field is determined based on contextual factors such as time of day, day of the week, month of the year, particular time trigger thresholds, speed of the user computing device, or transport modality associated with the user computing device, allowing the system to adapt to different conditions and scenarios.

In some instances, the method determines the probability based on a first probability associated with a first discrete region of the probability field and a second probability associated with a second discrete region of the probability field that is different than the first discrete region, enabling interpolation and weighted analysis across multiple grid locations to account for positioning uncertainty. The method may receive location data of the user computing device based on a configurable parameter, where the configurable parameter is based on a distance of the user computing device to the virtual boundary, allowing for more frequent location updates as customers approach the pickup location to improve accuracy during critical timing periods. The probability field represents a heat map comprising a plurality of pixels, where each pixel of the heat map represents the discretized location in the environment, with different colors or intensities indicating varying probability values for arrival within the specified time threshold.

The probabilistic event triggering system is designed with privacy protection as a fundamental principle, enabling accurate arrival predictions without requiring or accessing any personally identifiable information (PII) from customers. The system can operate entirely on anonymized location coordinates and timing data, focusing exclusively on spatial patterns and geographic characteristics rather than individual customer profiles, personal preferences, or behavioral tracking. This privacy-preserving approach ensures that customer data remains protected while still providing businesses with the operational insights needed for efficient service delivery.

The system takes a location-centric approach by transforming continuous location data into discrete spatial units, allowing for a focus on the inherent characteristics of geographic positions surrounding pickup locations rather than profiling individual users or analyzing driver behavior. By concentrating on spatial properties and building probability distributions based on specific regions, these methods produce probability fields that can be universally applied to any customer approaching a pickup site-regardless of individual driving habits, route choices, or past behaviors. This foundational strategy ensures the system's predictions remain broadly relevant and effective for diverse customer scenarios.

Probabilistic Event Triggering (PET): A system and method for predicting customer arrival times at pickup locations using historical location data processed into spatial probability distributions. The PET system addresses the limitations of conventional ETA prediction methods by leveraging extensive historical customer location data to create probability fields that represent the likelihood of a customer being within a specified time threshold of a site based on their current location. Unlike traditional mapping services that route to single point locations and fail to account for site-specific factors, the PET system processes historical customer data into a configurable grid system, applies filtering functions such as Gaussian blur to generate smooth probability distributions, and uses these probability fields to trigger events with significantly improved accuracy. The system operates by collecting location data from user computing devices as they approach pickup locations, determining when devices entered virtual boundaries associated with the premises, and mapping historical arrival patterns onto discretized spatial grids to build predictive models that account for multiple entrance points, contextual variables, and site-specific characteristics.

Discretized Grid: A spatial framework that subdivides the geographic area surrounding a pickup location into uniform grid cells for probability analysis and event triggering. The discretized grid typically employs configurable cell sizes, such as 5-meter grid cells, where each cell or pixel represents a discrete spatial unit that can be assigned probability values based on historical location data. The system associates location data (e.g., continuous location data) from user computing devices with specific discretized locations on the map, enabling the transformation of real-world geographic coordinates into a structured grid format suitable for probability field generation. Each grid cell serves as a data collection point where historical arrival patterns are aggregated, allowing the system to build spatial probability distributions that reflect the likelihood of customers reaching the pickup location within specified time thresholds. The discretized grid provides the foundational structure for applying filtering functions, interpolation techniques, and probability calculations that enable accurate event triggering based on customer location patterns.

Probability Field: A spatial distribution of probability values across a discretized grid that indicates the likelihood of a customer arriving at a pickup location within a specified time period based on their current location. The probability field is generated by processing historical location data through filtering functions such as Gaussian blur, which smooths discrete data points into continuous probability distributions that account for spatial uncertainty and generalize arrival patterns to nearby locations. Each location within the probability field is assigned a probability value that represents the historical likelihood of customers at that position reaching the pickup location within the designated time threshold, such as 60 seconds or another configurable trigger timing. The probability field enables the system to evaluate current customer locations against historical patterns, determining when the probability of arrival meets or exceeds threshold values that warrant triggering preparation activities. Multiple probability fields may be generated and selected based on contextual factors such as time of day, day of the week, weather conditions, transportation modality, or specific time trigger thresholds, allowing the system to adapt to varying conditions and scenarios that affect customer arrival patterns. In some examples, a probability field may be referred to as a heat map.

Virtual Boundary: A geofence or polygonal area that defines the perimeter around a pickup location for detecting customer arrivals and triggering events. The virtual boundary represents a digital perimeter that encompasses the physical premises or specific pickup zones such as drive-through entrances, curbside parking areas, store parking lots, or other designated customer arrival points. The system receives data indicating when user computing devices enter the virtual boundary, which serves as the reference point for measuring arrival times and building historical datasets used in probability field generation. Virtual boundaries can be configured to match predefined geographic areas, dynamically generated based on site characteristics, or determined by merchants to align with specific operational requirements and pickup location layouts. The virtual boundary enables the system to establish consistent arrival detection across different pickup scenarios while accounting for multiple entrance points and varying site configurations that traditional single-point routing systems cannot accommodate.

Blurring Function: A mathematical filtering technique, typically implemented as a Gaussian blur function, that transforms discrete historical location data points into smooth, continuous probability distributions across the discretized grid. The blurring function addresses the inherent spatial uncertainty in location data by spreading probability values from specific data points to adjacent grid cells, creating generalized probability regions that account for GPS accuracy limitations and natural variations in customer movement patterns. The Gaussian blur function applies a kernel with configurable size and standard deviation parameters that can be tuned for optimal accuracy based on site-specific characteristics and historical performance data. By applying the blurring function to aggregated location data, the system generates probability fields that provide continuous spatial coverage rather than isolated probability points, enabling more robust event triggering decisions that account for positioning uncertainty and interpolation across multiple grid locations.

Bayesian Algorithm: A statistical updating method that enables continuous learning and adaptation of probability fields by incorporating new location data while preserving accumulated knowledge from historical observations. The Bayesian approach treats existing probability fields as prior distributions representing current beliefs about spatial arrival patterns, then combines these priors with new evidence in the form of recent location and arrival data to generate updated posterior distributions. This cyclical updating process allows the system to continuously refine probability field accuracy without requiring complete reprocessing of historical datasets, as the posterior distribution from each update cycle automatically becomes the prior for subsequent updates. The Bayesian algorithm provides a mathematically robust framework for managing the balance between historical trends and recent observations, naturally weighting the influence of new data while maintaining the statistical foundation built from extensive historical patterns. This approach enables the system to adapt to changing conditions, seasonal variations, and evolving customer behavior patterns while preserving the predictive value of accumulated historical data.

The techniques described herein can improve the functioning of a computing device in a number of ways. For example, the probabilistic event triggering system significantly reduces computational overhead by eliminating the need for repeated queries to external mapping services, which traditionally require continuous API calls and network communications that consume bandwidth and processing resources. By pre-computing probability fields from historical data and storing them as efficient image-based representations, the system enables rapid probability lookups through simple pixel coordinate translations, reducing processing time from seconds to milliseconds compared to conventional real-time routing calculations. The discretized grid approach with configurable cell sizes optimizes memory usage by allowing systems to balance spatial resolution with storage requirements, enabling deployment on resource-constrained devices while maintaining accuracy. Additionally, the Bayesian updating mechanism improves computational efficiency by incrementally refining probability models without requiring complete reprocessing of historical datasets, reducing the computational load associated with model retraining and enabling continuous learning with minimal system impact. The system's ability to trigger events with sub-10-second accuracy compared to traditional methods that exhibit 30-120 second errors represents a substantial improvement in timing precision that enhances operational safety by reducing food waste, preventing overcooking, and minimizing customer wait times. Furthermore, the configurable location update frequency based on proximity to the destination optimizes network usage and battery consumption by requesting more frequent updates only when precision is most critical, thereby improving overall system performance and device longevity.

The techniques described herein can be implemented in a number of ways. Example implementations are provided below with reference to the following figures. Although discussed in the context of food pickup scenarios and restaurant operations, the methods, apparatuses, and systems described herein can be applied to a variety of scenarios and are not limited to food service applications. For example, the probabilistic event triggering system can be utilized in retail pickup scenarios, pharmacy order fulfillment, package delivery and logistics, automotive service appointments, healthcare facility arrivals, educational institution events, entertainment venue management, or any other context where accurate arrival time prediction and event triggering based on location data would be beneficial.

Additionally, while the examples herein focus on ground-based transportation such as cars, trucks, and other vehicles, the techniques can be adapted for use with various transportation modalities including bicycles, motorcycles, scooters, public transportation systems, pedestrian movement, watercraft navigation to marinas or docks, aircraft arrivals at airports or landing facilities, drone delivery systems, or any other form of transportation where location tracking and arrival prediction would enhance operational efficiency. The system can work with real location data captured using GPS sensors, cellular positioning, or other location determination technologies, simulated data generated for testing and optimization purposes, or any combination thereof to provide flexible implementation across diverse operational environments and use cases.

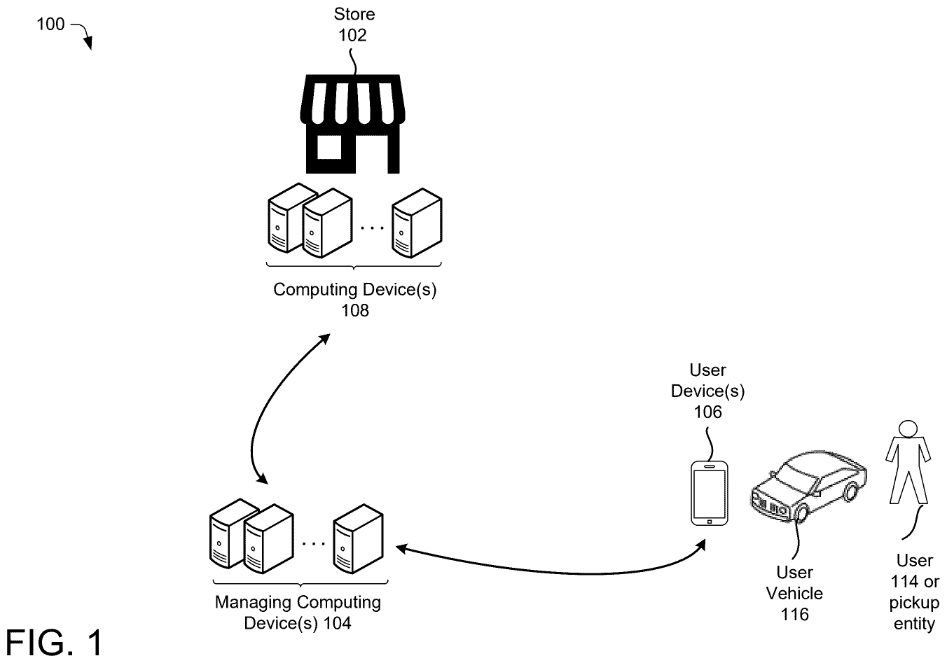

FIG. 1 illustrates an example environment 100 including a store (e.g., store 102), one or more managing computing device(s) 104, and one or more user device(s) 106, in accordance with examples of the disclosure. For example, the store may include, but is not limited to, a restaurant, a supermarket, a grocery store, a cosmetic store, a shopping mall, a department store, a pharmacy, a vehicle rental center, and so on.

The store may have one or more computing devices associated with the store. For example, the store 102 can have one or more computing device(s) 108 associated with the store 102. In some examples, the store 102 may communicate with the managing computing device(s) 104 via the computing device(s) 108. In some examples, the managing computing device(s) 104 may send notifications and/or instructions to the computing device 108. In some examples, the computing device(s) 108 may be communicatively coupled with one or more order queues, an order-preparation robot (e.g., a food preparation robot, a robot to collect items or prepare an order, etc.), and the like.

The computing device(s) 108 can communicate with one or more user devices 106 and/or the user vehicle 116. In some examples, user devices 106 and the user vehicle 116 can be associated with the user 114 or a third party. For example, the third party can be a pickup entity that is picking up such as delivery drivers, delivery bikers, driverless vehicles, or the like. In some examples, the user 114 (e.g., a customer and/or requesting party or requesting entity) can make the order and pick up the order by herself. Additionally or alternatively, the order can be made by the user 114 while the order can be picked up by the pickup entity that provides picking up and delivery services. In some examples, the managing computing device(s) 104 may receive orders (e.g., food pickup orders) from the user device(s) 106. In some examples, the user device(s) 106 may collect location data and send the location data to the managing computing device(s) 104. Additionally, or alternatively, the user vehicle 116 may collect location data and send the location data to the managing computing device(s) 104.

In some examples, the location data may include, but is not limited to, a latitude, a longitude, an accuracy, and/or a speed of the user device(s) 106 and/or the user vehicle 116. In some examples, the location data can be updated in a predetermined period of time, in real-time, in near real-time, etc. In some examples, the location data may include an estimated time of arrival received from a map provider or a third party service.

In some examples, the managing computing device(s) 104 may send data/messages to the user device(s) 108 and/or the user vehicle 116 associated with the user 114. For example, the user device(s) 106 can send location data to the computing device(s) 108 (or data from which a location of the user device(s) 106 can be determined. For example, the user device(s) 106 can send location data to the managing computing device(s) 104 and the managing computing device(s) 104 can determine a location relative to one of the first store 102 or another store. In some examples, the first store 102 and/or the other store can be associated with a geo-fence such that the managing computing device(s) 104 can determine if the user device(s) 106 is within a geofence area. In some examples, the user device(s) 106 can send a beacon signal to a wireless transmitter associated with the first store 102, and the managing computing device(s) 104 can determine, upon receipt of an indication of the beacon signal, whether the user device(s) 106 is within a threshold distance of the first store 102. Additional details are discussed throughout the disclosure.

The user vehicle 116 can include but is not limited to cars, trucks, buses, wagons, motorcycles, scooters, bicycles, boats, airplanes, helicopters, drones, or hovercrafts.

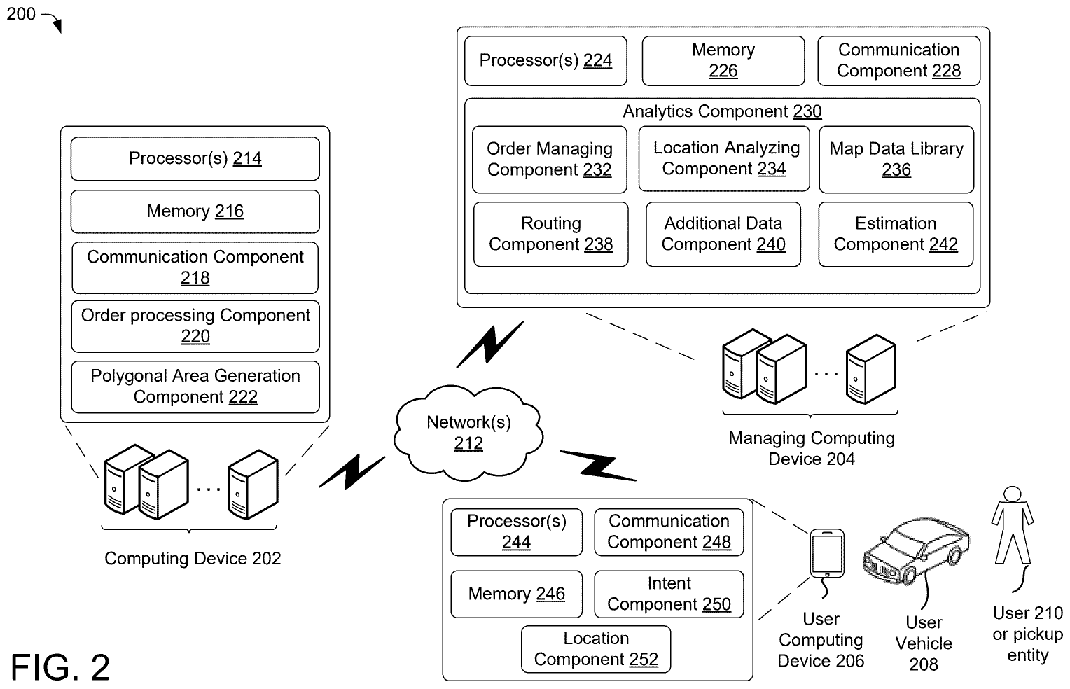

FIG. 2 illustrates an example environment 200 that is usable to implement the techniques and systems described herein. The environment 200 can include a computing device associated with a store, such as the computing device 202. The environment 200 can also include one or more managing computing devices, such as the managing computing device 204, which can provide processing and analytics. The environment 200 can also include one or more user computing devices, such as user computing device 206, and a user vehicle 208 associated with a user 210 or a third party. For example, the third party can be a pickup entity that is picking up an item from the store, an entity, such as delivery drivers, delivery bikers, or the like. In some examples, the user 210 can make the order and pick up the order by themselves. Additionally or alternatively, the order can be made by the user 210 while the order can be picked up by the pickup entity that provides picking up and delivery services. In various examples, the computing device 202, the managing computing device 204, and the user computing device 206 can communicate wired or wirelessly via one or more networks 212.

The managing computing device 204 can also be configured to communicate alerts, reports, analytics, recommendations, instructions, graphical user interfaces, etc., to the user computing device 206 and/or the user vehicle 208 associated with the user 210.

The computing device 202 (and/or any of the computing devices discussed herein) can individually include, but is not limited to, any one of a variety of devices, including portable devices or stationary devices. For instance, a device can comprise a data logger, an embedded system, a programmable logic controller, a sensor, a monitoring device, a smart phone, a mobile phone, a personal digital assistant (PDA), a laptop computer, a desktop computer, a tablet computer, a portable computer, a server computer, a wearable device, or any other electronic devices. In various examples, the computing device 202 can correspond to the first computing device(s) 108 in FIG. 1.

The computing device 202 can include one or more processor(s) 214 and memory 216. The processor(s) 214 can be a single processing unit or a number of units, each of which could include multiple different processing units. The processor(s) 214 can include a microprocessor, a microcomputer, a microcontroller, a digital signal processor, a central processing unit (CPU), a graphics processing unit (GPU), a security processor, etc. Alternatively, or in addition, some or all of the techniques described herein can be performed, at least in part, by one or more hardware logic components. For example, and without limitation, illustrative types of hardware logic components that can be used include a Field-Programmable Gate Array (FPGA), an Application-Specific Integrated Circuit (ASIC), an Application-Specific Standard Products (ASSP), a state machine, a Complex Programmable Logic Device (CPLD), pulse counters, resistor/coil readers, other logic circuitry, a system on chip (SoC), and/or any other devices that perform operations based on instructions. Among other capabilities, the processor(s) 214 can be configured to fetch and execute computer-readable instructions stored in the memory 216.

The memory 216 can include one or a combination of computer-readable media. As used herein, “computer-readable media” includes computer storage media and communication media. Computer storage media includes volatile and non-volatile, removable and non-removable media implemented in any method or technology for storage of information, such as computer-readable instructions, data structures, program modules, or other data. Computer storage media includes, but is not limited to, Phase Change Memory (PRAM), Static Random-Access Memory (SRAM), Dynamic Random-Access Memory (DRAM), other types of Random-Access Memory (RAM), Read Only Memory (ROM), Electrically Erasable Programmable ROM (EEPROM), flash memory or other memory technology, Compact Disc ROM (CD-ROM), Digital Versatile Discs (DVD) or other optical storage, magnetic cassettes, magnetic tape, magnetic disk storage or other magnetic storage devices, or any other medium that can be used to store information for access by a computing device. In contrast, communication media includes computer-readable instructions, data structures, program modules, or other data in a modulated data signal, such as a carrier wave. As defined herein, computer storage media does not include communication media. In some examples, non-transitory computer-readable media does not include communication media.

The memory 216 can include an operating system configured to manage hardware and services within and coupled to a device for the benefit of other modules, components, and devices. In some examples, the computing device 202 can include one or more servers or other computing devices that operate within a network service (e.g., a cloud service), or can form a mesh network, etc.

The computing device 202 can also include a communication component 218 to communicate with other computing device(s) (e.g., in mesh network) and/or to communicate via the network(s) 212. For example, the communication component 218 can perform compression, encryption, and/or formatting of the data. In some examples, the communication component 218 can transmit data using one or more protocols or languages, such as an extensible markup language (XML), Modbus, HTTP, HTTPS, USB, etc.

The computing device 202 can also include an order processing component 220. In some examples, the order processing component 220 can receive order data from the managing computing device 204 via the network(s) 212. In some examples, the order processing component 220 can receive instructions from the managing computing device 204 via the network(s) 212 to prepare orders. In some examples, the order processing component 220 can receive notifications from the managing computing device 204 via the network(s) 212 to cancel or delay orders. In some examples, the order processing component 220 can keep an order queue. For example, the store can prepare orders based on the order queue. The order processing component 220 can sort orders in the order queue based on the priority (and/or ETA) associated with the order. As such, orders with higher priorities can be in higher positions in the order queue (and will be made/prepared earlier), while orders with lower priorities can be in lower positions in the order queue (and will be made/prepared later).

In some examples, the order processing component 220 can determine the priorities of the orders based on a First-Arrived-First-Out (FAFO®) rule. That is, the customer who arrives first at the store will be prioritized higher than another customer who has not yet arrived at the store. For example, a first user has a first arrival time of 9:30 am, while a second user has a second arrival time of 9:45 am. Then, the order processing component 220 can prioritize the first order associated with the first user. As such, the first order associated with the first user can have a higher priority (be in a higher position in the order queue), while a second order associated with the second user can have a lower priority (be in a lower position in the order queue). In some examples, the arrival time of the user can be an estimated time of arrival (ETA). In some examples, the order processing component 220 can insert an order with an earlier ETA to usurp the order queue. For example, a second user can make a second order before a first user who makes a first order. However, a second ETA of the second user is ahead of a first ETA of the first user, and thus the second order associated with the second user is prioritized against the first order associated with the first user.

Additionally or alternatively, the order processing component 220 can determine the priorities of the orders based on the preparation time of each order. An order with a shorter preparation time can be in a lower position in the order queue, and an order with a longer preparation time can be in a higher position in the order queue. For example, a first order associated with a first user has a first preparation time of 2 minutes, while a second order associated with a second user has a second preparation time of 4 minutes. Then, the order processing component 220 can prioritize the first order. As such, the first order associated with the first user can have a higher priority (be in a higher position in the order queue), while a second order associated with the second user can have a lower priority (be in a lower position in the order queue). In some examples, the preparation time of the order can be an estimated preparation time.

In some examples, the order processing component 220 can determine the priorities of the orders based on a combination of different factors. For example, a first order associated with a first user has a first estimated arrival time of 9:30 am but only takes 2 minutes to prepare, while a second order associated with a second user has a second estimated arrival time of 9:35 am but takes 4 minutes to prepare. Then the order processing component 220 can prioritize the first order associated with the first user. As another example, a first order associated with the first user has a first estimated arrival time of 9:35 am and takes 2 minutes to prepare, while a second order associated with a second user has a second estimated arrival time of 9:30 and takes 4 minutes to prepare. Then the order processing component 220 can prioritize the second order associated with the second user. As yet another example, a first order associated with the first user has a first estimated arrival time of 9:30 am and takes 2 minutes to prepare, while a second order associated with a second user has a second estimated arrival time of 9:30 and takes 4 minutes to prepare. Then the order processing component 220 can prioritize the second order associated with the second user.

In some examples, the order processing component 220 can insert a new order in the order queue when receiving the new order based on a priority associated with the new order and the priorities of other orders already in the order queue.

In some examples, the computing device 202 may include a polygonal generation component 222, which may generate polygonal areas around the store, in which a polygonal area may correspond to a pick-up location. For example, the store may be associated with a polygonal area, which may be a geofence area, such that the managing computing device 204 may determine if the user device 206 is within the polygonal area. As described herein, a polygonal area can represent a virtual perimeter for a real-world geographic area. In some examples, multiple polygonal areas may be associated with the store, wherein the multiple polygonal areas are associated with various pick-up locations in which the user 210 may pick up good(s) ordered from the store. For example, a first polygonal area may correspond to an area around a drive-through location of the store, such as a drive-through entrance. A second polygonal area may correspond to a parking lot associated with the store, while a third polygonal area may correspond to designated curbside pick-up locations (e.g., individual parking locations) or spots.

In some examples, the polygonal area could be dynamically generated or match a predefined set of boundaries. In other examples, the polygonal area may be determined by an owner of the store, such as a merchant. In some examples, the polygon areas can be determined by annotating image data (e.g., obtained via drone or satellite) or identify particular regions proximate the store.

The use of a geofence is called geofencing, and one example of use involves a location-aware device of a location-based service user entering or exiting a geofence. In some examples, the user device 206 can send a beacon signal to a wireless transmitter associated with the store, and the managing computing device 204 can determine, upon receipt of an indication of the beacon signal, whether the user device 206 is within a threshold distance of a polygonal area. Based on determining that the user computing device 206 is within a threshold distance of the polygonal area, the analytics component 230 may send, to the computing device 202, an indication that the user computing device 206 is within the threshold distance of the polygonal area, thus allowing the store to adequately prepare the user's 210 order.

The managing computing device 204 can include one or more processor(s) 224, a memory 226, and a communication component 228, each of which can be implemented similar to the processor(s) 214, the memory 216, and/or the communication component 218 of the computing device 202.

In some examples, the managing computing device 204 can include an analytics component 230, including one or components such as an order managing component 232, a location analyzing component 234, a map data library 236, a routing component 238, an additional data component 240, and an estimation component 242.

The analytics component 230 can receive order data from the computing device 202 and can store the order data in the order managing component 232. In some examples, the order data may include data indicative of item data (which may indicate items ordered by the user, e.g., tacos, burritos, salads, a service, or the like), combo data (which may indicate combos ordered by the user, e.g., bowl combo, cheese quesadilla combo, breakfast combo, or the like), ingredient data (which may indicate ingredients ordered by the user, e.g., rice, beans, chicken, steak, pulled pork, lettuce, pico de gallo, sour cream, or the like), preference data (which may indicate preferences associated with the user, e.g., sweet, sour, salty, bitter, savory preferences, or the like), food allergy data (which may indicate food allergies associated with the user, e.g., gluten allergy, peanut allergy, seafood allergy, or the like), discount data (which may indicate the discount information associated with the user, e.g., promo codes, coupons, credits, or the like), membership data (which may indicate membership information associated with the user), payment data (which may indicate payment information associated with the user, such as debit card information, credit card information, PayPal information, check information, or the like) associated with the user 210, or the like. In some examples, the order managing component 232 can store the timestamp data associated with the order data input from the computing device 202.

In some examples, the order data may include a destination intent associated with picking up a good or service. For example, order data may specify where a user is intending to pick up an order, such as in a curbside parking location, through a drive through, at a loading dock, at a pickup window or counter, or the like.

In some examples, the analytics component 230 can receive location data from the user computing device 206 and/or the user vehicle 208. In some examples, the analytics component 230 can store the location data in the location analyzing component 234. In some examples, the location data can indicate the location of the user computing device 206 and/or the user vehicle 208 associated with the user 210 or the pickup entity. In some examples, the location data can include Global Positioning System (GPS) data, sensor data, cellular location data (e.g., base station data or the like), indoor positioning data (e.g., WIFI beacon data, Bluetooth beacon data, or the like), mobile phone application data that share a user's location (e.g., a fitness app that monitors the user's steps and locations), and so on. In some examples, the location data can include a latitude associated with the user computing device 206 (or the user vehicle 208), a longitude associated with the user computing device 206 (or the user vehicle 208), an accuracy associated with location data, a speed associated with the user computing device 206 (or the user vehicle 208), or timestamp data associated with the location data. In some examples, the location data can be updated in a predetermined period of time, in real-time, in near real-time, etc.

The analytics component 230 can include a map data library 236 which includes map data. In some examples, the map data can include land boundary data of roads (e.g., streets, freeways, highways, bridges, or the like), buildings (e.g., houses, hotels, hospitals, offices, or the like), facilities (e.g., parking lots, gas stations, churches, libraries, or the like), green spaces (e.g., parks, gardens, woods, or the like), waters (e.g., rivers, lakes, seas, or the like), and so on. In some examples, the map data can include, but is not limited to, imagery data, terrain data, latitude and longitude coordinates, transit data, traffic data, or the like. In some examples, the analytics component 230 can determine, using the location analyzing component 234, whether the location associated with the user computing device 206 and/or the user vehicle 208 is within a threshold distance to one or more stores based on the location data and the map data. For example, the user computing device 206 can send location data to the computing device(s) 206 (or data from which a location of the user computing device 206 can be determined. For example, the user computing device 206 can send location data to the managing computing device 204 and the managing computing device 204 can determine a location relative to the store.

The analytics component 230 can include a routing component 238. In some examples, the routing component 238 can be configured to determine routes from one location to another location. For example, the routing component 238 can determine routes from the user 210's location to one or more stores based on the location data and/or the map data. In some examples, the routing component 238 can be configured to determine routes based on different requirements such as the shortest travel distance, the shortest travel time, the lowest traffic, or the like.

In some examples, the analytics component may include an additional data component 240. The additional data component 240 may be configured to determine factors that may affect the user's 210 arrival time or that affect wait times associated with the store. This may include a variety of factors such as, but not limited to, a time of day, a minute of a day, an hour of a day, a day of a week, a month of a year, whether a day is a holiday, a current number of pending and completed orders at the store, or a number of customers at the store, a direction between the user device and the store (e.g., North, South, East, West, Northwest, Southwest, (or any coarse or fine directional indicators, such as bearing or heading between a user device 206 and a store location) etc.), traffic data, a history of previous orders associated with the customer, a speed and/or acceleration of the pickup vehicle, a current occupancy of a parking lot associated with the store, or a current weather, order volume associated with the store, a number of customers associated with a location of the store, wait time associated with the store, order throughput data associated with the store, to name a few examples.

The analytics component 230 can include an estimation component 242. In some examples, the estimation component 242 may include a machine-learning model and can be configured to determine an estimated arrival time of the user 210 or the pickup entity at least based on the location data, the map data, the pickup intent, and/or the additional data. In some examples, the estimated arrival time can be indicative of a time the customer will arrive at a user-designated polygonal area. Designating a polygonal area is generated by the intent component 250, which is discussed below.

In some examples, the estimation component 242 may utilize machine-learning models(s) that may be configured to determine an ETA of the user 210 to the polygonal area associated with the intended pick-up location. For example, the machine-learning model(s) may be configured to receive a request and output one or more ETAs that may be associated with the request, as well as confidence level associated with the ETA(s). In some examples, the machine-learning model(s) may be a deep neural network or a random decision forest model. In some examples, the estimation component 242 may utilize a variety of machine-learning model(s). In some examples, the estimation component 242 may train the machine-learning model(s) by using training data specific to the store the order is associated with. Training the machine-learning model(s) is discussed in more detail, below.

In some examples, the estimation component 242 may train the machine-learning model(s) to determine one or more ETAs associated with the request(s). Additionally, or alternatively, the estimation component 242 may train the machine-learning model(s) to determine respective confidence levels associated with the ETA(s). In some examples, the estimation component 242 may first train the machine-learning model(s) when a new request for an ETA has been received by the estimation component 242 (e.g., or any time thereafter when an updated request for an ETA is received), in addition to re-training the machine-learning models periodically. In some examples, the estimation component 242 may re-train the machine-learning model(s) automatically. Such re-training of the machine-learning model(s) may be based on a number of factors. Factors may include, for example, how frequently orders are placed at the store, a number of customers at a store, a number of requests for ETA being made, determinations that a difference between the ETA and the actual time of arrive exceeds a threshold amount, and/or any other similar factor.

The machine-learning model(s) may be trained, using training data, to receive input from the user computing device 206 and/or the computing device 202 and generate, as output, an ETA of the user 210 arriving at the store. For example, input may include, but is not limited to, route information from the routing component 238, map data from the map data library 236, additional data from the additional data component 240, location data from the location component 252, and/or intent data from the intent component 250. However, the machine-learning model(s) may use, as input, any data from any component(s) of the managing computing device 204, the user computing device 206, and/or the computing device 202. As described above, the machine-learning model(s) may be trained using a variety of training data. In some examples, training data may include information regarding prior ETAs associated with prior orders placed at the store.

In other examples, training data may include prior confidence levels associated with prior request to generate prior ETAs. For example, confidence levels may be assigned to one or more ETAs which have been previously generated by the machine-learning models, wherein a higher confidence level is associated with a higher likelihood an ETA is correlated to the actual time the user arrives at the store, thus resulting in a higher probability that the ETA is correct. Alternatively, a lower confidence score is associated with a lower likelihood that ETA is correlated to the actual time the user arrives at the store, thus resulting in a lower probability that the ETA is correct. In some examples, the estimation component 242 may associate the information regarding the prior ETAs with prior confidence levels such that the machine-learned model(s) may use such learned relationship to generate one or more new ETAs and one or more new confidence scores associated with the new ETAs.

In some examples, the estimation component 242 may train machine-learning model(s) using training data specific to the location with which the machine-learning model(s) will be used, such as a specific restaurant or store. For example, the estimation component 242 may train machine-learning model(s) based at least in part on interaction data associated with a particular store or location. Interaction data may include data regarding previous interactions at the store, such as orders, average wait times, pickup times, and the like. Interaction data may additionally or alternatively include ETAs which were previously generated for previous orders at the store. Further, interaction data may include confidence levels associated with ETAs that were determined at a previous time. In such examples, the estimation component 242 may use the interaction data as training data in order to learn the relationship between the ETAs and confidence levels, thus gaining a better understanding of ETAs corresponding to certain locations and stores. In this way, the machine-learning model(s) may rely on data associated with particular spaces to generate ETAs tailored specifically to those spaces.

In some examples, a machine learning model can be trained to minimize the loss or error between an actual arrival time at a location (e.g., specified in ground truth data) and the estimated time of arrival output by the model. The loss can be determined and can be input to the model to determine parameters to minimize the loss. The model can be trained iteratively, for example, using gradient descent, until a number of iterations are performed or until a desired precision is reached. In some examples, weights or parameters of the machine learning model can be updated to generate or otherwise determine the trained machined learning model.

The user computing device 206 can include one or more processor(s) 244, a memory 246, and a communication component 248, each of which can be implemented similar to the processor(s) 214, the memory 216, and/or the communication component 248.

In some examples, the user computing device 206 may include an intent component 250. The intent component 250 may receive from the user 210, an input corresponding to an intended pick-up location. The intended pick-up location may correspond to a location in which the user 210 desires to pick up their order from the store. This may include, for example, drive-through pick-up, curbside pick-up, or in-store pick-up. In some examples, intent component 250 may receive, from the user 210, the intended pick-up location upon receiving, from the user, the order. The intent component 250 may send the intent to the managing computing device 204, in which the pick-up intent may be stored in the order managing component 232.

In some examples, the user computing device 206 may send the pick-up intent to the computing device 202, such as to the order processing component 220 and/or the polygonal area generation component 222. For example, the order processing component 220 may place a drive-through order higher in the queue than an in-store pickup order, as it may take the user 210 longer to find a parking spot and walk into the store than it takes a user to access the store's drive through window. In some examples, a pickup order may correspond to a takeaway order or a dine-in order where the customer or requesting party orders ahead.

In some examples, a pick-up intent may correspond to a polygonal area. For example, an order with an intent of a drive-through pickup may correspond to a polygonal area associated with a drive-through, such as a drive-through entrance. Alternatively, an order with a pick-up intent of curbside may correspond to a polygonal area associated with designated curbside pick-up parking spots. Similarly, an order with a pick-up intent of in-store may correspond to a polygonal area associated with the store's parking spots. While this application describes drive-through, curbside, or in-store as pickup options, any pickup locations and options may be used herein.

The user computing device 206 can also include a location component 252 to collect location data associated with the user computing device 206. In some examples, the location data can include Global Positioning System (GPS) data, sensor data, cellular location data (e.g., base station data or the like), indoor positioning data (e.g., WIFI beacon data, Bluetooth beacon data, or the like), mobile phone application data that share a user's location (e.g., a fitness app that monitors the user's steps and locations), and so on. In some examples, the location data can include a latitude associated with the user computing device 206, a longitude associated with the user computing device 206, an accuracy associated with location data, a speed associated with the user computing device, or timestamp data associated with the location data. In some examples, the location data can be updated in a predetermined period of time, in real-time, in near real-time, etc.

The environment 200 also includes the user 210 who can employ the user computing device 206 and the user vehicle 208. In some examples, the user vehicle 208 can have similar functions discussed with respect to the user computing device 206. In some examples, the user 210 or the pickup entity can interact with the user computing device 206 to perform a variety of operations. In some examples, the user 210 can make orders (e.g., food pickup orders) via the user computing device 206. In some examples, the user 210 or the pickup entity can review the information displayed via the user computing device 206. In some examples, the user 210 or the pickup entity can review the location data indicating the location of the user 210 (or the user vehicle 208). In some examples, the location of the user computing device 206 (or the user vehicle 208) can be updated in a predetermined period of time, in real-time, in near real-time, etc. In some examples, the user 210 or the pickup entity can review the messages/alerts displayed via the user computing device 206 (or the user vehicle 208) and follow the instructions to reroute from the location associated with the user computing device 206 (or the user vehicle 208) to the first store (correct store or intended store). Additionally or alternatively, the user 210 or the pickup entity can review the messages/alerts displayed via the user computing device 206 (or the user vehicle 208).

The network(s) 212 can include the Internet, a Mobile Telephone Network (MTN), Wi-Fi, a cellular network, a mesh network, a Local Area Network (LAN), a Wide Area Network (WAN), a Virtual LAN (VLAN), a private network, and/or other various wired or wireless communication technologies.

The operations of the computing device 202, the managing computing devices 204, and the user computing device 206 are further provided in connection with the various figures of this disclosure. Further, any of the functions or operations provided by one component can be provided by any other component discussed herein. That is, features of the managing computing device 204 can be provided by the computing device 202, and/or the user computing device 206 (or the user vehicle 208), and vice versa. For example, the computing device 202 can also have analytic components to perform similar operations discussed with regard to managing computing device 204.

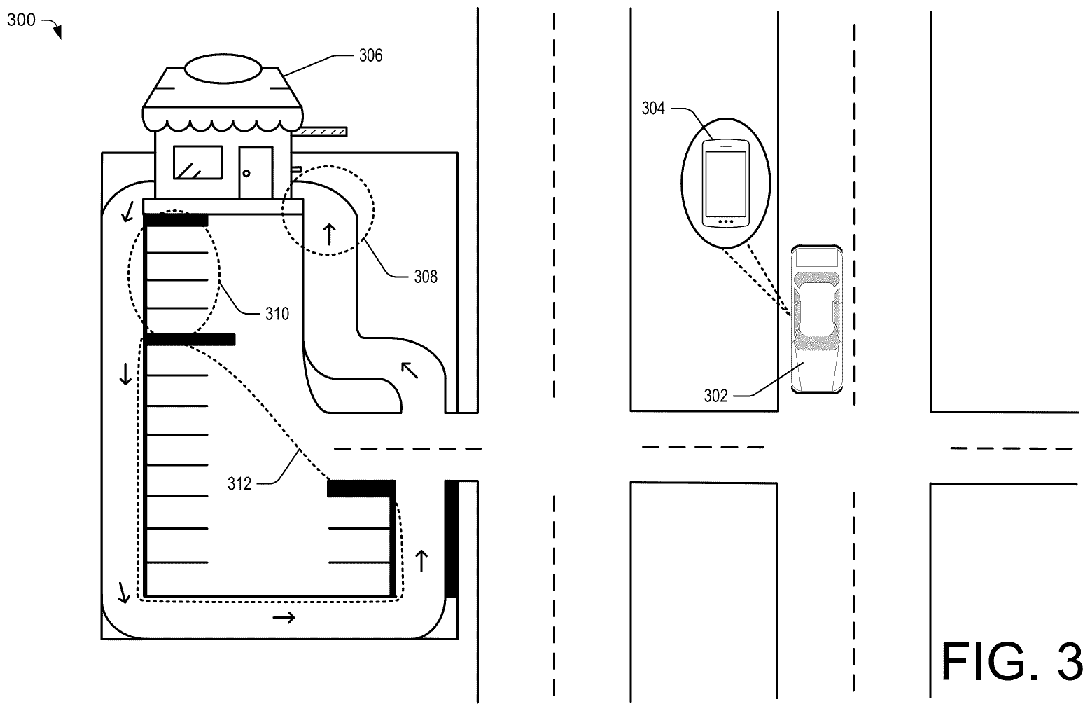

FIG. 3 illustrates another example environment 300 that is usable to implement the techniques and systems described herein. For example, the example environment 300 illustrates a birds-eye view of a user traveling to pick-up an order from a store. For example, the user may be traveling in a vehicle, such as user vehicle 302. In some examples, the user may additionally have a device associated with the user, such as user device 304. In some examples, the user device 304 may have GPS capabilities such that the user device 304 may send location data associated with the user device 304 to a computing device associated with the store, such as store 306, such that the store may determine how far the user is from the store.

In some examples, the user may place an order to pick-up at the store. For example, the store 306 may be a coffee store. In some examples, the user may place the order to pick up a cappuccino at the store 306 via the user device 304. When placing the order, the user may determine a pick-up intent, which may correspond to the physical location that the user wishes to pick up the coffee. A pickup intent may include, for example, drive-through, curbside, or in-store, to name a few examples.

In some examples, the pickup intent may correspond to a polygonal area. The polygonal area may be a geofence, or a virtual perimeter, such that a computing device associated with the polygonal area and the user computing device 304 may determine when the user computing device comes into contact with or within a threshold distance of the polygonal area. In some examples, the store 306 may have various polygonal areas which may be associated with the various pickup locations. For example, the store 306 may include a first polygonal area 308 associated with a drive-through pickup, which may be located at an entrance of the store's 306 drive-through; a second polygonal area 310 associated with a curbside pickup, which may be located at the store's 306 designated curbside pickup parking spots; and/or a third polygonal area 312 associated with an in-store dining and/or pickup, which may be located at the store's parking lot.

Continuing with the illustrative example above, suppose the user selects in-store as the designated pick-up location. To maintain the satisfaction of the store's customers, it may be important to the store that coffees ordered for pick-up are still hot and fresh when the customer arrives. Thus, knowing an ETA and location of the customer may determine a time in which the order is started. Suppose, for example, it may take the store 3 minutes to make a cappuccino. Based on the size of the parking lot, the average time to park and walk into the store may be 5 minutes. Thus, the store 306 may start making the cappuccino 2 minutes after receiving an indication that the customer is within the polygonal area associated with the store's 306 parking lot.

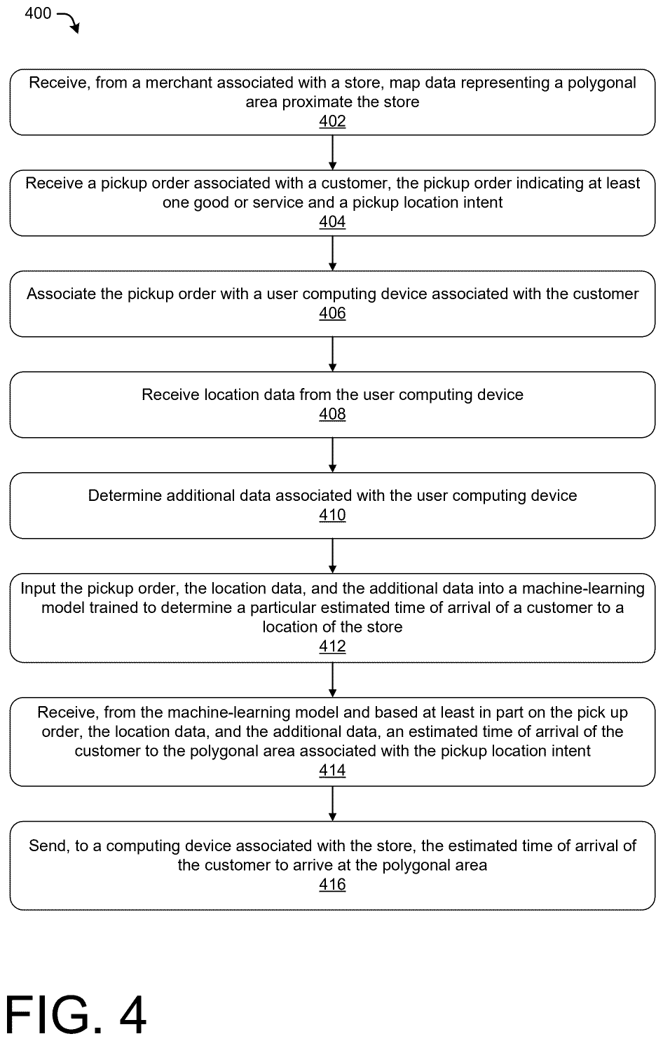

FIG. 4 illustrates an example process 400 for determining estimated arrival times of customers to specified pick-up locations at stores in accordance with examples of this disclosure. In some examples, at least some operations of the process 400 may be performed by the computing device(s) 108 in FIG. 1, the managing computing device(s) 104 in FIG. 1, the user device(s) 106 in FIG. 1, the user vehicle 116 in FIG. 1, the computing device 202 in FIG. 2, the managing computing device 204 in FIG. 2, the user computing device 206 in FIG. 2, the user vehicle 208, as described herein.

For example, at operation 402, the process 400 may include at least receiving, from a merchant associated with a store, map data representing a polygonal area proximate the store.

At operation 404, the process 400 may include at least receiving a pickup order associated with a customer. In some examples, the pickup order may indicate at least one good or service. For example, the store may be, but is not limited to, a restaurant, a supermarket, a grocery store, a cosmetic store, a shopping mall, a department store, a pharmacy, a vehicle rental center, and so on. In some examples, the pickup order may additionally or alternatively include a pickup intent. A pickup intent may include, for example, a way in which the customer wishes to pick up the good or service from the store. This may include, for example, a drive-through pickup (in which the customer may pick-up the good or service via a drive-through associated with the store), a curbside pickup (in which the customer may pick-up the good or service at a curbside pickup location associated with the store), or an in-store pickup (in which the customer may park in a parking lot associated with the store and walk into the store to pick-up the good or service), to name a few non-limiting examples.

At operation 406, the process 400 may include at least associating the pickup order with a user computing device associated with the customer. For example, the pickup order may be placed on a user computing device associated with the customer. In some examples, the order may be placed by the user online, such as via a website or an application associated with the store. In other examples, the order may be placed via a third-party application or service.

At operation 408, the process 400 may include at least receiving location data from the user computing device. For example, the user computing device may contain one or more GPS systems which may enable the user computing device to determine location data. In some examples, the location data may include at least one of a latitude associated with the user device, a longitude associated with the user device, an accuracy associated with the location data, a speed associated with the user device, or timestamp data associated with the location data. In some examples, the location data is updated in a predetermined period of time, in real-time, or in near real-time.

At operation 410, the process 400 may include at least determining additional data associated with the user computing device. Additional factors may include one or more factors that may affect the estimated arrival time of the customer. These may include, but are not limited to, a time of a day, a minute of a day, an hour of a day, a day of a week, a month of a year, whether a day is a holiday, a current number of orders at the store, or a number of customers at the store, a direction between the user device and the store (e.g., North, South, East, West, Northwest, Southwest, etc.), traffic data, a history of previous orders associated with the customer, a speed and/or acceleration of the customer's vehicle, a current occupancy of a parking lot associated with the store, or a current weather, to name a few examples.

At operation 412, the process 400 may include at least inputting pickup order, the location data, and the additional data into a machine-learning model trained to determine a particular estimated time of arrival of a customer to a location of the store. The machine-learning model may be a machine-learning model configured to determine an ETA of the user to the polygonal area associated with the store. For example, the machine-learning model may be configured to receive a request and output one or more ETAs that may be associated with the request, as well as confidence level associated with the ETA(s). In some examples, the machine-learning model may be a deep neural network, a random decision forest model, or the like.

At operation 414, the process 400 may include at least receiving, from the machine-learning model and based at least in part on the pickup order, the location data, and the additional data, an estimated time of arrival of the customer to the polygonal area associated with the pickup location intent.

At operation 416, the process 400 may include at least sending, to a computing device associated with the store, the estimated time of arrival of the customer to arrive at the polygonal area. The computing device associated with the store may be accessible to the merchant and/or one or more employees of the store who may be responsible for preparing the order. By knowing an accurate ETA of the customer, the employees of the store may adequately and timely prepare the order for the customer.

The techniques discussed above can be implemented in hardware, software, or a combination thereof. In the context of software, operations represent computer-executable instructions stored on one or more computer-readable storage media that, when executed by one or more processors, configure a device to perform the recited operations. Generally, computer-executable instructions include routines, programs, objects, components, data structures, or the like that perform particular functions or implement particular abstract data types.

The probabilistic event triggering system transforms location data from user computing devices into a structured spatial framework that enables accurate probability analysis and event triggering. This transformation process involves converting real-world geographic coordinates into discrete grid locations that can be systematically analyzed to build predictive models for customer arrival patterns. The discretization approach provides a standardized method for organizing location data across different geographic areas and enables consistent probability calculations regardless of the specific characteristics of individual pickup locations.

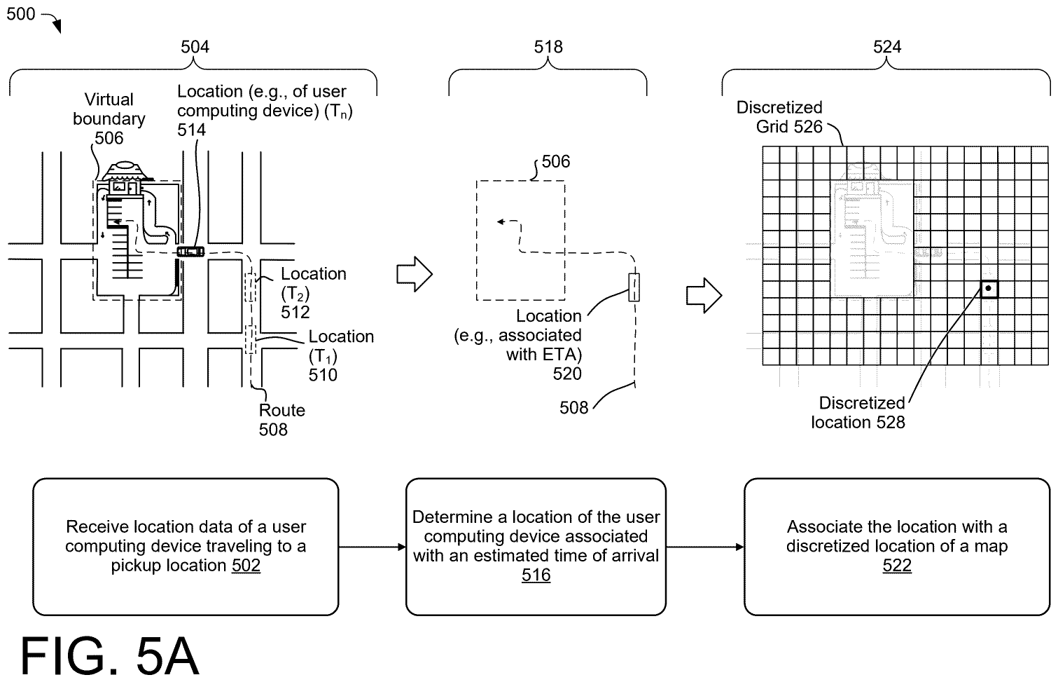

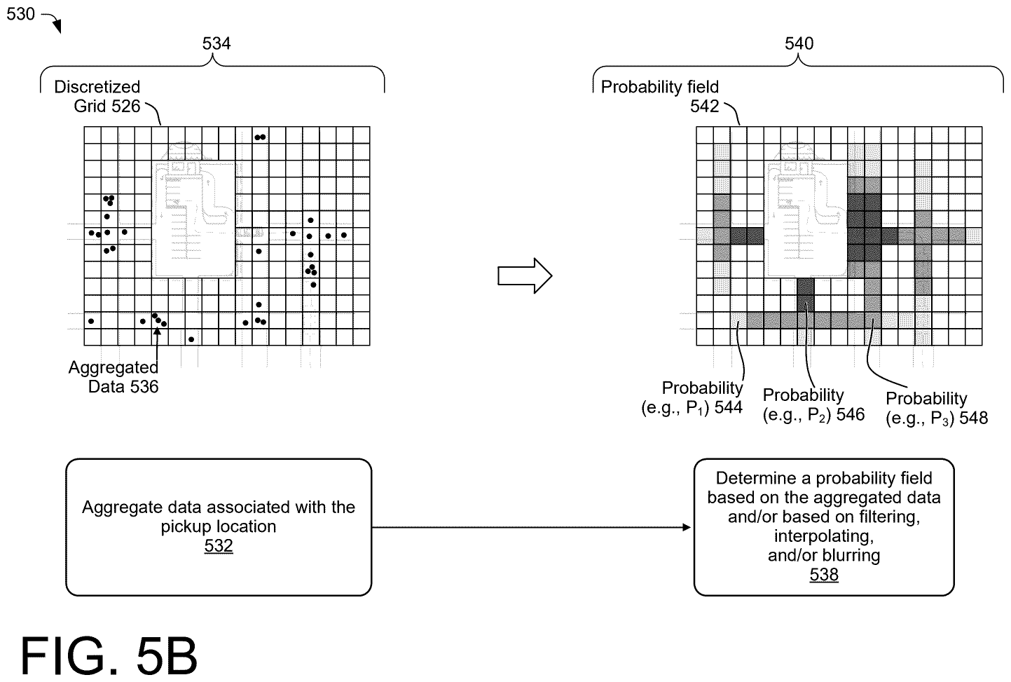

Referring to FIG. 5A, the process of associating location data with discretized locations begins with the collection of location information from user computing devices as they travel toward pickup destinations. The system receives location data that represents the real-time positions of customers throughout their journey, capturing the spatial progression of movement patterns that will be used to build historical datasets for probability field generation. This location data may include coordinates, timestamps, and other positioning information that provides a comprehensive record of customer movement behavior in the vicinity of pickup locations.

The transformation from location coordinates to discrete grid positions involves mapping real-world geographic data onto a structured spatial framework that divides the area surrounding a pickup location into uniform cells or regions. This discretization process enables the system to organize location data into manageable units that can be systematically analyzed for probability calculations and pattern recognition. The grid-based approach provides a consistent method for aggregating location data across multiple customer journeys and enables the system to identify spatial patterns that would be difficult to detect using continuous coordinate systems.

In some examples, the discretization process may involve determining which grid cell corresponds to a particular set of geographic coordinates, allowing the system to associate location data with specific discrete positions on the spatial grid. This association enables the aggregation of multiple location observations within the same grid cell, building statistical datasets that reflect the frequency and timing of customer presence at different spatial locations. The discretized approach facilitates the application of mathematical functions and algorithms that generate probability distributions from the aggregated location data, providing the foundation for accurate event triggering based on spatial probability analysis.

With continued reference to FIG. 5A, the system 500 implements a location tracking process that begins with a step 502 for receiving location data from a user computing device as the user computing device (illustrated as being associated with a vehicle) approaches a pickup location. An example 504 illustrates details of the step 502. The user computing device may be associated with a customer or pickup entity traveling toward a store or service location, and the location data collection process enables the system to monitor the progression of the user computing device throughout the journey to build historical datasets for probability field generation.

As shown in FIG. 5A, the user computing device travels along a route 508 that demonstrates the typical movement pattern of customers approaching a pickup location. The route 508 illustrates how the user computing device progresses through various spatial positions during the approach phase, with the system collecting location data at multiple points along the journey to capture comprehensive movement patterns. The route 508 may represent any path that a customer takes when traveling to a pickup location, including direct routes, circuitous paths due to traffic conditions, or alternative approaches based on parking availability and entrance accessibility.

The system tracks multiple locations along the route 508, including a location 510 that represents an early position in the customer's journey, a location 512 that may correspond to an intermediate position, and a location 514 that represents a position closer to the destination. The location 514 is shown outside a virtual boundary 506, demonstrating how the system monitors customer positions both within and outside the defined pickup area. These multiple location points enable the system to build comprehensive spatial datasets that capture the full spectrum of customer approach patterns and movement behaviors in the vicinity of pickup locations.

The virtual boundary 506 represents a geofence or polygonal area that defines the perimeter around the pickup location for detecting customer arrivals and establishing reference points for probability field generation. Unlike conventional systems that rely on single-point routing, the virtual boundary 506 is defined by entry into the pickup location premises delineated by a boundary line rather than a single point, accounting for multiple entrances and varying site configurations. This approach enables the system to accommodate complex pickup locations with multiple access points, such as stores with separate drive-through entrances, curbside pickup areas, and pedestrian entrances, providing more accurate arrival detection than traditional geofencing methods.

In some examples, the location data may be received approximately every two seconds, with the frequency adjusting based on proximity to the pickup location. This dynamic frequency adjustment enables the system to optimize data collection efficiency while ensuring adequate spatial resolution for accurate probability calculations. As the user computing device approaches the virtual boundary 506, the system may increase the frequency of location updates to capture more detailed movement patterns during the critical final approach phase, while reducing update frequency when the user computing device is at greater distances where precise positioning is less critical for event triggering decisions.

The system addresses challenges for customers very close to a pickup location, particularly in urban areas, and those who order but do not immediately depart from their origin location. In urban environments, customers may be located within close proximity to pickup locations but still require time to navigate through traffic, find parking, or access the appropriate entrance. The probabilistic approach accounts for these urban proximity scenarios by analyzing historical patterns of customers who were geographically close to pickup locations but required additional time to complete their arrival due to site-specific factors such as parking availability, traffic congestion, or building access requirements.

Additionally, the system handles scenarios where customers place orders but do not immediately begin traveling toward the pickup location, which can occur when customers order in advance or experience delays in departing from their current location. The probability field generation process incorporates these delayed departure patterns into the spatial analysis, enabling the system to trigger events appropriately even when customers remain at their initial location for extended periods after placing orders. This capability prevents premature event triggering that could result in food preparation beginning too early or other operational inefficiencies caused by inaccurate assumptions about customer departure timing.

With continued reference to FIG. 5A, the process advances to a step 516 for determining a location of the user computing device when the user computing device was a particular time period away from entering the virtual boundary 506. This determination process involves analyzing the historical location data collected during the approach phase to identify specific spatial positions that correspond to predetermined time thresholds before arrival at the pickup location. The step 516 enables the system to establish spatial reference points that can be used to build probability fields for predicting when future customers at similar locations may arrive at the pickup location.

The step 516 utilizes the collected location data from the route 508 to perform temporal-spatial analysis that correlates specific geographic positions with arrival timing patterns. For example, the system may analyze the location data to determine that when the user computing device was at the location 510, the user computing device was approximately 120 seconds away from entering the virtual boundary 506, while when the user computing device was at the location 512, the user computing device was approximately 90 seconds away from entering the virtual boundary 506. (Of course, these values are merely exemplary). This temporal-spatial correlation enables the system to build datasets that associate specific geographic coordinates with consistent arrival timing patterns across multiple customer journeys.

As shown in FIG. 5A, example 518 represents an area where the system performs the determination process for identifying historical positions associated with specific time thresholds. The example 518 may encompass multiple spatial positions where customers have historically been located when they were a particular time period away from entering the virtual boundary 506, such as 60 seconds, 90 seconds, or other configurable time thresholds that correspond to desired event triggering timing. The analysis within the example 518 enables the system to identify spatial patterns and correlations that form the basis for probability field generation and accurate event triggering.

The determination process results in the identification of a location 520 that represents a specific spatial position where the user computing device was located when it was the particular time period away from entering the virtual boundary 506. The location 520 serves as a reference point for building probability distributions that indicate the likelihood of customers at similar spatial positions arriving at the pickup location within the specified time threshold. In some examples, the location 520 may correspond to a position where the user computing device was exactly 60 seconds away from entering the virtual boundary 506, providing a precise spatial reference for triggering preparation activities or other operational events.

The system may determine multiple historical locations associated with various time thresholds to accommodate different operational requirements and event triggering scenarios. For example, the system may identify locations where customers were historically 30 seconds, 60 seconds, 90 seconds, or 120 seconds away from entering the virtual boundary 506, enabling the creation of multiple probability fields that correspond to different preparation timing requirements. A restaurant may use a 60-second threshold for beginning food preparation, while a pharmacy may use a 90-second threshold for retrieving prescription orders, demonstrating how the configurable time thresholds can be adapted to different business operational needs.

In some instances, the determination process accounts for variations in customer approach patterns based on contextual factors such as time of day, traffic conditions, or transportation modality. The system may determine that customers traveling by car during peak traffic hours were historically located at different spatial positions when they were 60 seconds away from entering the virtual boundary 506 compared to customers traveling during off-peak hours or customers arriving on foot. This contextual analysis enables the generation of multiple probability fields that account for varying conditions and scenarios, improving the accuracy of event triggering across different operational contexts.

The location 520 and other determined historical positions provide the spatial foundation for the discretization process that transforms location data into structured grid coordinates suitable for probability field generation. Each determined location represents a data point that contributes to the statistical analysis of customer arrival patterns, enabling the system to build comprehensive spatial datasets that reflect the likelihood of customers reaching the pickup location within specified time thresholds based on their current geographic position.

With continued reference to FIG. 5A, the process proceeds to a step 522 for associating the location with a discretized location of a map of an environment proximate the pickup location. The step 522 represents the transformation phase where continuous geographic coordinates are converted into structured grid coordinates that enable systematic probability analysis and spatial pattern recognition. This discretization process provides the foundation for generating probability fields by organizing location data into uniform spatial units that can be consistently analyzed across multiple customer journeys and different pickup locations.

As shown in FIG. 5A, an example 524 illustrates aspects of the step 522. In some example, the example 524 illustrates a discretized grid 526 that overlays the geographic area surrounding the pickup location to provide a structured spatial framework for location analysis. The discretized grid 526 divides the continuous geographic space into uniform cells or regions, where each cell represents a discrete spatial unit that can be assigned probability values based on historical location data patterns. The discretized grid 526 enables the system to aggregate location observations from multiple customers within the same spatial regions, building statistical datasets that reflect the frequency and timing of customer presence at different positions around the pickup location. In some examples, the discretized grid 526 may represent any shape, and in some examples, the discretized grid 526 may correspond to individual pixels of an image or heat map.

The discretization process maps the location 520, which represents the determined historical position where the user computing device was a particular time period away from entering the virtual boundary 506, onto the discretized grid 526 that provides the spatial structure for probability field generation. The discretized grid 526 may be configured with various resolution settings to balance spatial precision with computational efficiency and storage requirements. In some examples, the discretized grid 526 employs a configurable 5-meter grid resolution where each pixel or cell represents a discrete spatial unit with dimensions of approximately 5 meters by 5 meters, providing sufficient spatial granularity for accurate probability calculations while maintaining manageable data processing requirements.

The mapping process results in the identification of a discretized location 528 that corresponds to the specific grid cell or pixel within the discretized grid 526 where the location 520 is positioned. The discretized location 528 represents the discrete spatial coordinate that will be used for probability field generation and statistical analysis of customer arrival patterns. By associating the continuous geographic coordinates of the location 520 with the discretized location 528, the system enables the aggregation of multiple location observations within the same grid cell, facilitating the calculation of probability values that reflect the likelihood of customers at that spatial position arriving at the pickup location within specified time thresholds.

The configurable grid resolution of the discretized grid 526 may be adjusted based on the specific characteristics of different pickup locations and operational requirements. For example, pickup locations in dense urban environments with complex access patterns may benefit from higher resolution grids with smaller cell sizes, such as 2-meter or 3-meter grid cells, to capture fine-grained spatial variations in customer approach patterns. Conversely, pickup locations in suburban or rural areas with more straightforward access routes may utilize larger grid cells, such as 10-meter or 15-meter cells, to optimize computational efficiency while maintaining adequate spatial precision for accurate event triggering. In some examples, a size of the grid may be proportional to the distance between the grid and the pickup location. That is, in some examples, a size of the grid may decrease as the distance to the pickup location decreases, which may improve accuracy at close distances while reducing computation or memory requirements overall for a data structure.

The transformation from location data to discrete spatial units enables the system to focus on location characteristics rather than individual user profiling or driver behavior analysis. This location-centric approach analyzes the spatial properties of different geographic positions around pickup locations, building probability distributions that reflect the inherent characteristics of specific spatial regions rather than the behavioral patterns of individual customers. By focusing on location characteristics, the system generates probability fields that are applicable to any customer approaching the pickup location, regardless of their individual driving habits, route preferences, or historical behavior patterns.

In some examples, the discretization process may involve coordinate transformation algorithms that convert latitude and longitude coordinates into pixel coordinates within the discretized grid 526. This transformation enables efficient probability lookups by translating a customer's current location into grid coordinates that can be rapidly evaluated against the stored probability field data. The coordinate transformation process may account for geographic projection considerations and coordinate system variations to ensure accurate spatial mapping across different geographic regions and coordinate reference systems.

The discretized location 528 serves as a data collection point where historical arrival patterns are aggregated to build statistical datasets for probability field generation. Multiple customer journeys that pass through the same grid cell contribute to the probability calculations for the discretized location 528, enabling the system to determine the likelihood of customers at that spatial position reaching the pickup location within specified time thresholds. This aggregation approach provides statistical robustness by combining observations from multiple customers, reducing the impact of individual variations and outliers while identifying consistent spatial patterns that can be used for accurate event triggering.

The probabilistic event triggering system employs a systematic approach for transforming discrete historical location data into continuous probability distributions that enable accurate prediction of customer arrival patterns. This transformation process addresses the inherent challenge of converting individual location observations collected from multiple customer journeys into smooth, spatially coherent probability fields that can be used for reliable event triggering decisions. The generation of probability fields from aggregated location data represents a fundamental component of the system that enables the transition from raw spatial observations to actionable probability distributions suitable for operational decision-making.

Referring to FIG. 5B, the system implements a comprehensive method for generating probability fields that converts discrete location data points into continuous spatial probability distributions. The method addresses the spatial discontinuity that results from collecting location data at specific discrete positions by applying mathematical functions that create smooth probability transitions across the spatial grid. This approach enables the system to generate probability values for spatial regions where direct historical observations may not be available, providing comprehensive spatial coverage that accounts for the natural variations and uncertainties inherent in location data collection and customer movement patterns.

The probability field generation process transforms the structured spatial framework established through discretization into dynamic probability distributions that reflect the likelihood of customer arrivals within specified time thresholds. This transformation involves analyzing the aggregated location data collected at discrete grid positions and applying filtering and interpolation techniques that create continuous probability surfaces across the entire spatial domain surrounding pickup locations. The resulting probability fields provide a comprehensive spatial representation of arrival likelihood that enables the system to evaluate customer positions anywhere within the coverage area and determine appropriate event triggering decisions based on statistical analysis of historical arrival patterns.

In some examples, the probability field generation method incorporates statistical analysis techniques that account for the frequency and consistency of historical observations at different spatial positions. The method may analyze the temporal patterns associated with location data to ensure that probability calculations reflect not only the spatial distribution of historical arrivals but also the timing consistency and reliability of those arrival patterns. This comprehensive analysis enables the generation of probability fields that provide robust predictions for event triggering while accounting for the natural variations in customer behavior and external factors that may influence arrival timing.

The continuous probability distributions generated through this method enable the system to perform interpolation and weighted analysis across multiple spatial regions, accommodating positioning uncertainty and GPS accuracy limitations that are inherent in location-based systems. By creating smooth probability transitions between discrete observation points, the method ensures that customers located between historical observation positions can still receive accurate probability assessments based on the spatial characteristics of their current location. This interpolation capability enhances the robustness and reliability of the event triggering system by providing consistent probability evaluations regardless of the specific spatial positioning of customers relative to historical observation points.

With continued reference to FIG. 5B, the system implements a method 530 for generating probability fields from historical location data collected at pickup locations. The method 530 provides a systematic approach for transforming discrete location observations into continuous probability distributions that enable accurate event triggering based on spatial analysis of customer arrival patterns. The method 530 addresses the challenge of converting individual location data points collected from multiple customer journeys into coherent probability fields that can be used for reliable prediction of arrival timing at pickup locations.

The method 530 begins with a step 532 for aggregating data associated with the pickup location, where historical location data from multiple customer journeys is collected and organized within the spatial framework established by the discretization process. The step 532 involves systematically gathering location observations that have been collected over time as customers approached the pickup location, creating comprehensive datasets that reflect the spatial distribution of customer presence at different positions around the pickup location. This aggregation process enables the system to build statistical foundations for probability field generation by combining location data from numerous customer interactions to identify consistent spatial patterns and arrival timing correlations.

As shown in FIG. 5B, the step 532 is associated with an example 534 illustrating the discretized grid 526 that provides the spatial structure for organizing and aggregating the historical location data collected from customer journeys. The discretized grid 526 serves as the framework for systematically collecting location observations within uniform spatial units, enabling the system to build statistical datasets that reflect the frequency and timing of customer presence at different grid positions. Each cell within the discretized grid 526 may accumulate multiple location observations from different customers who were present at that spatial position during their approach to the pickup location, providing the data foundation for calculating probability values associated with each discrete spatial region.

The aggregation process results in aggregated data 536 that represents the accumulated location observations collected within each cell of the discretized grid 526. The aggregated data 536 may include multiple data points plotted as individual observations within the spatial grid, where each data point represents a historical instance of a customer being present at that specific grid location when they were a particular time period away from entering the virtual boundary associated with the pickup location. The aggregated data 536 provides the statistical basis for probability field generation by demonstrating the spatial distribution of historical customer positions and the frequency of observations at different locations around the pickup location.

In some examples, the aggregated data 536 may include location observations collected from hundreds or thousands of customer journeys over extended time periods, providing robust statistical datasets that account for variations in customer approach patterns, seasonal changes, and different operational conditions. The data aggregation process may collect observations from customers approaching the pickup location from various directions, using different transportation modalities, and during different times of day or days of the week. This comprehensive data collection enables the system to build probability fields that reflect the full spectrum of customer arrival patterns and provide accurate predictions across diverse operational scenarios.

The aggregated data 536 demonstrates how individual location observations accumulate within specific grid cells to build statistical datasets for probability calculations. For example, a particular grid cell may contain multiple data points representing different customers who were historically present at that spatial position when they were 60 seconds away from entering the virtual boundary. The accumulation of these observations within the same grid cell enables the system to calculate the probability that a customer currently located at that position will arrive at the pickup location within the 60-second time threshold, based on the historical frequency and consistency of arrivals from that spatial location.

The data aggregation process may account for temporal factors that influence customer arrival patterns, such as time of day, day of the week, or seasonal variations that affect traffic conditions and customer behavior. The system may organize the aggregated data 536 into different datasets based on these temporal factors, enabling the generation of multiple probability fields that correspond to different operational conditions. For example, the system may maintain separate aggregated datasets for morning rush hour periods, afternoon periods, and evening periods, allowing the generation of time-specific probability fields that provide more accurate predictions for different operational contexts.

In some instances, the aggregation process may filter the collected location data to remove outliers or anomalous observations that do not represent typical customer arrival patterns. This filtering may involve identifying location observations that are significantly inconsistent with the majority of observations at similar spatial positions, such as customers who experienced unusual delays due to vehicle breakdowns, emergency situations, or other exceptional circumstances. By filtering outliers from the aggregated data 536, the system ensures that probability field generation is based on representative customer behavior patterns that provide reliable predictions for normal operational conditions.

The discretized grid 526 provides the spatial organization for the aggregated data 536, where each grid cell serves as a collection point for historical location observations that contribute to probability calculations for that specific spatial region. The grid-based organization enables efficient data management and retrieval, allowing the system to rapidly access historical observations associated with specific spatial positions when generating probability fields or evaluating current customer locations. The structured approach provided by the discretized grid 526 facilitates the systematic analysis of spatial patterns and enables consistent probability calculations across different areas surrounding the pickup location.

With continued reference to FIG. 5B, the method 530 proceeds to a step 538 for determining a probability field based on the aggregated data and/or based on filtering, interpolating, and/or blurring. Details of the step 538 are provided in an example 540. Step 538 represents the transformation phase where discrete location observations are converted into continuous probability distributions that provide comprehensive spatial coverage for event triggering decisions. This step addresses the inherent spatial discontinuity that results from collecting location data at specific discrete positions by applying mathematical functions that create smooth probability transitions across the discretized grid 526.

The step 538 utilizes filtering techniques to process the aggregated data 536 and remove noise or inconsistencies that may affect the accuracy of probability field generation. The filtering process may involve statistical analysis of the location observations within each grid cell to identify and address outliers or anomalous data points that do not represent typical customer arrival patterns. By applying filtering techniques, the system ensures that the probability field generation is based on representative historical data that provides reliable predictions for normal operational conditions.

The interpolation component of the step 538 addresses spatial regions where direct historical observations may be limited or unavailable by estimating probability values based on the characteristics of nearby grid cells with sufficient historical data. This interpolation process enables the system to generate probability values for spatial positions that may not have been directly observed in the historical dataset, providing comprehensive spatial coverage that accounts for the natural variations in customer approach patterns. The interpolation techniques ensure that the resulting probability field provides consistent probability evaluations across the entire spatial domain surrounding the pickup location.

As shown in FIG. 5B, the step 538 applies blurring functions to the aggregated data 536 to generate smooth probability distributions that account for spatial uncertainty and positioning variations inherent in location-based systems. The blurring process transforms the discrete data points from the aggregated data 536 into continuous probability distributions by spreading probability values from specific observation points to adjacent grid cells. This mathematical transformation creates generalized probability regions that provide more robust event triggering decisions by accounting for GPS accuracy limitations and natural variations in customer movement patterns.

The blurring function may comprise a Gaussian blur function that applies a mathematical kernel to the discrete location observations to create smooth probability transitions across the spatial grid. The Gaussian blur function utilizes configurable parameters including kernel size and standard deviation that can be tuned for accuracy optimization based on site-specific characteristics and historical performance data. The kernel size parameter determines the spatial extent of the blurring effect, controlling how far probability values are spread from their original observation points, while the standard deviation parameter controls the intensity distribution of the blurring effect, determining how probability values are weighted across the kernel region.

In some examples, the Gaussian blur kernel size and standard deviation may be optimized through iterative analysis of historical performance data to achieve optimal accuracy for specific pickup locations and operational requirements. The tuning process may involve testing different parameter combinations and evaluating the resulting probability field accuracy against actual customer arrival patterns to identify the parameter settings that provide the most reliable event triggering performance. This optimization process enables the system to adapt the blurring function parameters to the specific characteristics of different pickup locations, accounting for factors such as site layout, traffic patterns, and customer approach behaviors.

The step 538 results in the generation of a probability field 542 that represents the continuous probability distribution derived from the processed aggregated data 536. The probability field 542 demonstrates the transformation from discrete location observations to smooth probability surfaces that provide comprehensive spatial coverage for event triggering analysis. The probability field 542 enables the system to evaluate customer positions anywhere within the coverage area and determine appropriate event triggering decisions based on the likelihood of arrival within specified time thresholds.

As further shown in FIG. 5B, the probability field generation process produces the probability field 542 that displays the resulting probability distribution across the discretized grid 526. The probability field 542 includes multiple probability regions with varying probability values that correspond to different spatial locations around the pickup location. The probability field 542 demonstrates how the blurring and interpolation processes create continuous probability surfaces from the discrete historical observations, enabling comprehensive spatial analysis for event triggering decisions.

The probability field 542 includes a probability 544 that represents the probability value associated with a specific spatial region within the probability distribution. The probability 544 may correspond to a particular grid cell or spatial area where historical observations indicate a specific likelihood of customers arriving at the pickup location within the designated time threshold. In some examples, the probability 544 may represent a low probability region where historical data demonstrates consistent customer arrivals within the specified time period, indicating that customers currently located in that spatial area are less likely to arrive at the pickup location within the trigger timing threshold.

Additionally, the probability field 542 includes a probability 546 that represents a different probability value associated with another spatial region within the probability distribution. The probability 546 may correspond to a spatial area with different historical arrival patterns compared to the probability 544, reflecting variations in customer approach behaviors or site-specific factors that influence arrival timing from different spatial positions. The probability 546 demonstrates how the probability field 542 captures spatial variations in arrival likelihood, enabling the system to make location-specific event triggering decisions based on the characteristics of different spatial regions around the pickup location.

The probability field 542 further includes a probability 548 that represents yet another probability value associated with a third spatial region within the probability distribution. The probability 548 may correspond to a spatial area with distinct arrival characteristics compared to the probability 544 and the probability 546, illustrating how the probability field 542 accommodates the full spectrum of spatial variations in customer arrival patterns. The multiple probability values within the probability field 542 enable the system to perform nuanced event triggering decisions that account for the specific spatial characteristics of customer locations rather than applying uniform timing assumptions across all spatial positions.

The relative shading or intensity variations within the probability field 542 represent the relative probability values associated with different spatial locations, where darker or more intense regions may indicate higher probability values and lighter regions may indicate lower probability values. However, the specific shading patterns and intensity distributions shown in the probability field 542 are merely exemplary and may vary based on the actual historical data patterns, site-specific characteristics, and operational requirements of different pickup locations. The visual representation of the probability field 542 provides an illustrative example of how probability distributions may appear, but the actual probability values and spatial patterns will be determined by the specific historical data and mathematical processing applied to each individual pickup location.

The probability field 542 may be stored as an image format that enables efficient retrieval of probability values through coordinate transformation and pixel-based lookup operations. This image-based storage approach allows the system to rapidly translate a customer's current location coordinates into pixel coordinates within the stored probability field image, enabling immediate access to the corresponding probability value without requiring complex mathematical calculations during real-time event triggering evaluations. The image format storage provides computational efficiency by pre-computing the probability distributions and storing them in a format that supports rapid spatial queries and probability retrievals.

In some examples, the probability field storage format may utilize standard image file formats or specialized data structures that optimize memory usage and access speed for spatial probability queries. The coordinate transformation process may involve converting latitude and longitude coordinates into pixel coordinates within the stored probability field image, enabling the system to retrieve probability values by accessing specific pixel locations within the image data structure. This approach significantly reduces the computational overhead associated with real-time probability calculations and enables the system to provide rapid event triggering responses based on current customer locations.

The probability field generation and storage process may be enhanced through Bayesian algorithms that enable continuous model updates without requiring complete reprocessing of historical datasets. The Bayesian approach treats the existing probability field 542 as a prior distribution representing current beliefs about spatial arrival patterns, then combines this prior with new evidence in the form of recent location and arrival data to generate updated posterior distributions. This cyclical updating process allows the system to continuously refine probability field accuracy by incorporating new observations while preserving the accumulated knowledge from extensive historical datasets.

The Bayesian algorithm provides a mathematically robust framework for managing the balance between historical trends and recent observations, naturally weighting the influence of new data while maintaining the statistical foundation built from accumulated historical patterns. The continuous updating capability enables the system to adapt to changing conditions, seasonal variations, and evolving customer behavior patterns without requiring manual retraining processes or complete regeneration of probability fields. This automated updating approach ensures that the probability field 542 remains current and accurate over time while minimizing the computational resources required for model maintenance and optimization.

The probabilistic event triggering system utilizes the generated probability fields to make real-time decisions about when to initiate actions at pickup locations based on current customer positions and movement patterns. This event triggering process represents the operational application of the spatial probability analysis, where the system evaluates customer locations against the historical probability distributions to determine when the likelihood of arrival within specified time thresholds meets or exceeds predetermined trigger criteria. The event triggering capability transforms the statistical analysis of historical location data into actionable operational decisions that enable businesses to coordinate preparation activities, staff notifications, and other operational responses with precise timing based on probabilistic predictions of customer arrivals.

The event triggering process addresses the fundamental challenge of determining the optimal timing for initiating preparation activities and other operational responses when customers are approaching pickup locations. Unlike conventional systems that rely on fixed distance thresholds or basic time estimates, the probabilistic approach evaluates the likelihood of customer arrival based on the comprehensive analysis of historical arrival patterns from similar spatial positions. This probability-based evaluation enables more nuanced and accurate event triggering decisions that account for the spatial characteristics of different locations around pickup sites and the inherent variations in customer approach patterns that affect arrival timing.

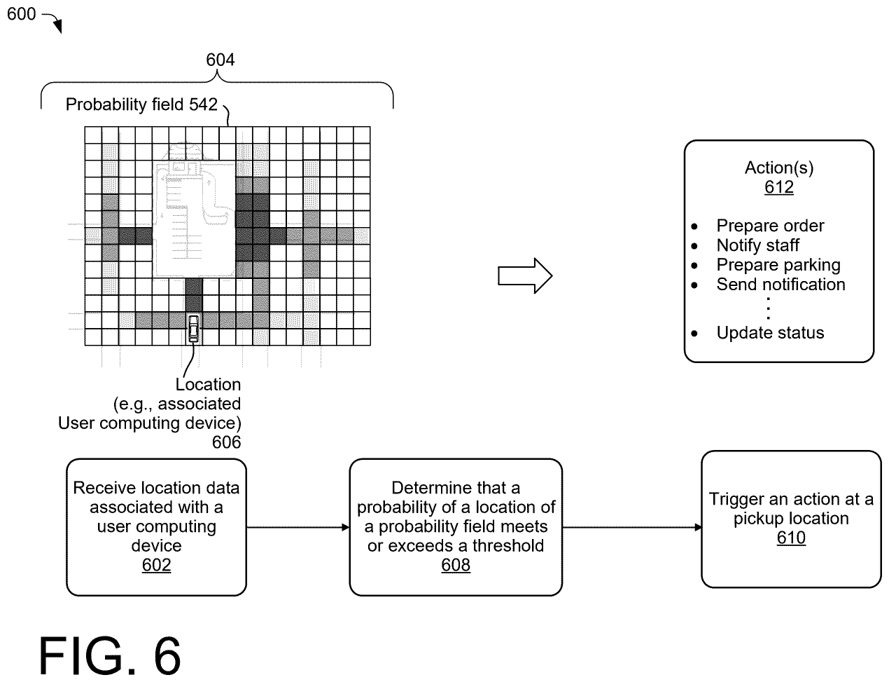

Referring to FIG. 6, the system implements a comprehensive process for event triggering that leverages the probability fields generated from historical location data to make informed decisions about when to initiate various actions at pickup locations. The process demonstrates how the system transitions from probability field analysis to operational action triggering, utilizing the spatial probability distributions to evaluate current customer positions and determine when the likelihood of arrival justifies initiating preparation activities or other operational responses. This process enables businesses to optimize their operational efficiency by triggering actions at precisely the right moments based on statistical analysis of customer arrival patterns rather than relying on fixed timing assumptions or basic distance calculations.

The event triggering process may accommodate various types of actions that businesses may need to coordinate based on customer arrival predictions, including food preparation activities, staff notifications, parking area preparation, customer communications, and status updates to operational systems. The flexibility of the event triggering framework enables different types of businesses to configure the system according to their specific operational requirements and timing constraints, whether they need to begin food preparation when customers are 60 seconds away, notify staff when customers are 90 seconds away, or initiate other operational responses based on different timing thresholds that align with their service delivery requirements.

With continued reference to FIG. 6, the system implements a process 600 for event triggering using probabilistic location data to determine when to initiate actions at pickup locations based on customer arrival predictions. The process 600 demonstrates the operational application of the probability fields generated from historical location data, where the system evaluates current customer positions against the spatial probability distributions to make informed decisions about when the likelihood of arrival within specified time thresholds justifies triggering preparation activities or other operational responses. The process 600 enables businesses to optimize their operational timing by initiating actions at precisely the right moments based on statistical analysis of customer arrival patterns rather than relying on conventional distance-based or time-based estimation methods.

The process 600 begins with a step 602 for receiving location data associated with a user computing device as the user computing device approaches the pickup location. The step 602 involves collecting real-time location information from customers or pickup entities who are traveling toward the pickup location, providing the current spatial position data that will be evaluated against the probability fields to determine appropriate event triggering decisions. The location data received in the step 602 may include GPS coordinates, cellular positioning information, or other location determination technologies that provide accurate spatial positioning for probability field analysis.

As shown in FIG. 6, example 604 correspond to the step 602. The step 602 utilizes a probability field 542 that represents the spatial probability distribution generated from historical location data collected at the pickup location. The probability field 542 provides the statistical foundation for evaluating current customer positions and determining the likelihood of arrival within specified time thresholds based on historical patterns of customer movement and arrival timing. The probability field 542 may be stored as an image-based representation that enables efficient probability lookups through coordinate transformation and pixel-based retrieval operations, allowing the system to rapidly access probability values associated with specific spatial positions.

The probability field 542 includes a location 606 that represents the current position of the user computing device within the spatial probability distribution. The location 606 demonstrates how the system maps real-time customer positions onto the probability field 542 to evaluate the likelihood of arrival within the designated time threshold based on historical arrival patterns from similar spatial positions. The location 606 may be determined through coordinate transformation processes that convert the received GPS coordinates or other location data into pixel coordinates within the stored probability field image, enabling immediate access to the corresponding probability value without requiring complex mathematical calculations during real-time evaluation.

The process 600 proceeds to a step 608 for determining that a probability of a location of the probability field meets or exceeds a threshold. The step 608 involves evaluating the probability value associated with the location 606 within the probability field 542 to determine whether the likelihood of customer arrival within the specified time period satisfies the predetermined trigger criteria established for the pickup location. The step 608 represents the decision-making component of the event triggering process, where the system compares the current probability assessment against configurable threshold values that correspond to the operational requirements and timing constraints of the business. In some examples, the threshold can be a dynamic parameter determined based on state data, user characteristics, customer preferences or historical data, order details, and the like.

The step 608 utilizes the location 606 and the probability field 542 to perform the threshold evaluation that determines whether event triggering is warranted based on the current customer position and historical arrival patterns. The probability field 542 provides the comprehensive spatial probability distribution that enables the system to assess the likelihood of arrival from the specific spatial position represented by the location 606. The threshold evaluation process may involve comparing a single probability value associated with the location 606 against a predetermined threshold, or may involve more complex analysis that considers multiple probability values from adjacent spatial regions to account for positioning uncertainty and GPS accuracy limitations.

In some examples, the step 608 may determine the probability based on a first probability associated with a first discrete region of the probability field 542 and a second probability associated with a second discrete region of the probability field 542 that is different than the first discrete region. This multi-region analysis enables interpolation and weighted evaluation across multiple grid locations to account for positioning uncertainty that may result from GPS accuracy limitations or natural variations in location reporting. The interpolated probability assessment provides more robust event triggering decisions by considering the spatial characteristics of the area surrounding the customer's current position rather than relying solely on a single discrete probability value.

The threshold probability values used in the step 608 may be configurable based on the specific operational requirements and risk tolerance of different businesses and pickup locations. For example, a restaurant that prioritizes food freshness may configure a higher threshold probability that triggers food preparation only when there is a high likelihood of customer arrival within the specified time period, while a business with more flexible preparation timing may utilize a lower threshold that triggers actions earlier in the customer approach process. The configurable threshold approach enables the system to adapt to different operational strategies and timing requirements across various business types and service delivery models.

Following the determination in the step 608, the process 600 proceeds to a step 610 for triggering an action at the pickup location based on the probability meeting or exceeding the threshold probability. The step 610 represents the operational response component of the event triggering process, where the system initiates specific actions that coordinate preparation activities, staff notifications, and other operational responses based on the probabilistic assessment of customer arrival timing. The step 610 transforms the statistical analysis of customer location and probability evaluation into concrete operational actions that enable businesses to optimize their service delivery timing and operational efficiency.

As shown in FIG. 6, the step 610 may initiate various actions 612 that represent the specific operational responses that can be triggered based on the probability assessment. The actions 612 include, but are not limited to, preparing an order, which may involve initiating food preparation activities, retrieving prescription medications, gathering retail items, or beginning other preparation processes that align with the predicted customer arrival timing. The order preparation action enables businesses to coordinate their preparation activities with customer arrival patterns, reducing wait times while minimizing waste from premature preparation or overcooking.

The actions 612 further include notifying staff, which may involve sending alerts to employees responsible for order fulfillment, customer service, or operational coordination to inform them of impending customer arrivals. The staff notification action enables businesses to optimize their workforce allocation and ensure that appropriate personnel are available and prepared to serve customers when they arrive at the pickup location. The notification system may provide staff with information about the specific order, customer preferences, and estimated arrival timing to facilitate efficient service delivery.

Additionally, the actions 612 include preparing parking, which may involve coordinating parking space availability, directing traffic flow, or managing curbside pickup areas to accommodate incoming customers. The parking preparation action addresses the logistical challenges associated with customer arrival management, particularly in busy locations where parking availability and traffic flow coordination can significantly impact customer experience and operational efficiency. The system may coordinate with parking management systems or staff to ensure that appropriate spaces are available when customers arrive.

The actions 612 also include sending a notification, which may involve communicating with customers to provide arrival confirmations, preparation status updates, or pickup instructions that enhance the customer experience and coordinate the final stages of the service delivery process. The customer notification action enables businesses to maintain communication with customers throughout the arrival process, providing transparency about preparation status and facilitating smooth coordination of the pickup interaction.

Furthermore, the actions 612 include updating status, which may involve modifying order management systems, inventory tracking, or operational dashboards to reflect the current status of customer arrivals and preparation activities. The status update action ensures that all relevant systems and personnel have current information about order progress and customer arrival status, enabling coordinated operational responses and accurate tracking of service delivery performance.

The process 600 achieves significant accuracy improvements compared to conventional ETA prediction systems, reducing error for event triggering to less than 10 seconds compared to traditional map providers that typically exhibit errors of 30 to 120 seconds. This substantial improvement in timing precision results from the probabilistic approach that accounts for site-specific factors, multiple entrance points, and historical arrival patterns that conventional mapping services cannot accommodate. The accuracy improvement enables businesses to trigger preparation activities with much greater precision, reducing food waste, preventing overcooking, and minimizing customer wait times while optimizing operational efficiency.

The system addresses challenges for customers very close to a pickup location, particularly in urban areas, and those who order but do not immediately depart from their origin location. In urban environments, customers may be geographically close to pickup locations but still require additional time to navigate through traffic congestion, find available parking spaces, or access the appropriate entrance points. The probabilistic approach accounts for these urban proximity scenarios by analyzing historical patterns of customers who were spatially close to pickup locations but required varying amounts of time to complete their arrival due to site-specific factors such as parking availability, traffic conditions, or building access requirements.

The system handles scenarios where customers place orders but do not immediately begin traveling toward the pickup location, which can occur when customers order in advance or experience delays in departing from their current location. The probability field generation process incorporates these delayed departure patterns into the spatial analysis, enabling the system to trigger events appropriately even when customers remain at their initial location for extended periods after placing orders. This capability prevents premature event triggering that could result in food preparation beginning too early or other operational inefficiencies caused by inaccurate assumptions about customer departure timing, while ensuring that preparation activities are initiated at the appropriate time when customers actually begin their approach to the pickup location.

The probabilistic event triggering system may be enhanced through the implementation of state-dependent probability fields that adapt to varying operational conditions and contextual factors that influence customer arrival patterns. This advanced approach recognizes that customer movement behaviors and arrival timing patterns can vary significantly based on environmental conditions, temporal factors, and other contextual variables that affect transportation and customer behavior around pickup locations. By generating or selecting different probability fields based on these state-dependent factors, the system can provide more accurate event triggering decisions that account for the dynamic nature of customer arrival patterns under different operational scenarios.

The state-dependent approach addresses the limitation of using a single probability field for all operational conditions by recognizing that customer arrival patterns may exhibit different characteristics during various times of day, weather conditions, traffic scenarios, or other contextual factors that influence movement behaviors. For example, customer approach patterns during morning rush hour periods may differ significantly from patterns during off-peak afternoon hours due to traffic congestion, route availability, and customer urgency levels. Similarly, weather conditions such as rain or snow may affect customer movement speeds and route selection, while different transportation modalities such as driving versus walking may result in distinct spatial approach patterns that warrant separate probability field analysis.

The system may maintain multiple probability fields that correspond to different operational states or contextual conditions, enabling the selection of the most appropriate probability distribution based on current environmental and operational factors. This multi-field approach allows the system to adapt its event triggering decisions to the specific conditions present during each customer arrival scenario, providing more accurate predictions that account for the contextual factors affecting customer movement and arrival timing. The state-dependent probability field selection process may involve analyzing current conditions and determining which historical dataset and corresponding probability field most closely matches the present operational scenario.

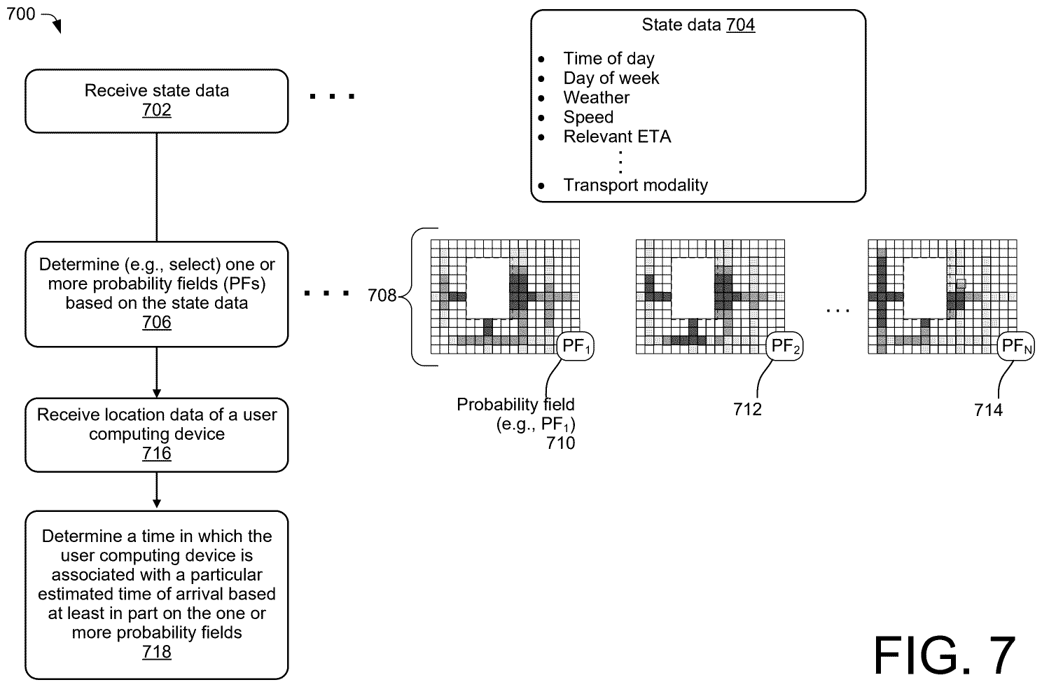

Referring to FIG. 7, the system implements an advanced process for event triggering that utilizes state-dependent probability fields to improve the accuracy of arrival predictions by accounting for contextual factors that influence customer movement patterns. The process demonstrates how the system can generate or select different probability fields based on various state parameters, enabling more nuanced event triggering decisions that adapt to changing operational conditions and environmental factors that affect customer arrival behaviors around pickup locations.

With continued reference to FIG. 7, a process 700 for event triggering using probabilistic models of location data begins with a step 702 for receiving state data 704 that includes various contextual parameters affecting customer arrival patterns. The step 702 enables the system to collect comprehensive information about current operational conditions and environmental factors that may influence customer movement behaviors and arrival timing patterns around pickup locations. The state data 704 provides the contextual foundation for determining which probability field or combination of probability fields may provide the most accurate predictions for current operational scenarios.

The state data 704 includes time of day information that captures the temporal context during which customer arrivals are occurring, recognizing that customer movement patterns may vary significantly between different periods of the day due to traffic conditions, customer urgency levels, and operational factors that affect transportation efficiency. For example, customer arrival patterns during morning rush hour periods between 7:00 AM and 9:00 AM may exhibit different spatial distributions and timing characteristics compared to mid-afternoon periods between 2:00 PM and 4:00 PM, when traffic congestion may be reduced and customers may have more flexible timing constraints. The time of day information enables the system to select probability fields that correspond to the specific temporal characteristics of current operational conditions.

Additionally, the state data 704 includes day of week information that accounts for weekly patterns in customer behavior and traffic conditions that may affect arrival timing and spatial approach patterns. Customer arrival behaviors on weekdays may differ substantially from weekend patterns due to variations in traffic volume, customer demographics, and operational contexts that influence transportation choices and timing flexibility. For example, customers arriving on weekday mornings may exhibit more predictable and time-constrained approach patterns due to work schedule pressures, while weekend customers may demonstrate more varied and leisurely approach behaviors that result in different spatial distributions and timing patterns around pickup locations.

The state data 704 further includes weather information that captures environmental conditions affecting customer movement speeds, route selection, and transportation modality choices that influence arrival patterns. Weather conditions such as rain, snow, or extreme temperatures may significantly impact customer approach behaviors by affecting driving speeds, parking availability, and customer willingness to walk longer distances from parking areas to pickup locations. For example, rainy weather conditions may result in customers seeking closer parking spaces and covered walkways, potentially altering the spatial distribution of approach patterns and increasing the time required for customers to complete their arrival process from parking areas to pickup locations.

The state data 704 includes speed information that reflects current traffic conditions and transportation efficiency factors that affect customer movement timing and arrival predictions. Speed data may be derived from real-time traffic monitoring systems, historical traffic pattern analysis, or direct observation of customer movement speeds in the vicinity of pickup locations. Variations in average movement speeds due to traffic congestion, construction activities, or special events may significantly impact the accuracy of arrival predictions, requiring the selection of probability fields that account for current speed conditions and transportation efficiency factors.

Transport modality information within the state data 704 captures the method of transportation being used by customers approaching the pickup location, recognizing that different transportation modes may result in distinct spatial approach patterns and timing characteristics. Customers arriving by car may exhibit different approach patterns compared to customers walking, biking, or using public transportation, with each modality potentially requiring separate probability field analysis to achieve accurate event triggering predictions. For example, customers driving to pickup locations may approach from parking areas or drive-through lanes with specific spatial patterns, while pedestrian customers may approach from public transportation stops or nearby locations with different spatial distributions and timing characteristics.

The state data 704 may include additional contextual information such as relevant estimated time of arrival data from external sources, special event indicators that may affect traffic or customer behavior, seasonal factors that influence customer patterns, or operational indicators such as current order volume or staffing levels that may affect service delivery timing. This comprehensive contextual information enables the system to make informed decisions about probability field selection and event triggering thresholds that account for the full spectrum of factors affecting customer arrival patterns under current operational conditions.

Different contextual factors within the state data 704 may affect arrival patterns in various ways that warrant separate probability field analysis or adjusted event triggering parameters. During peak traffic periods, customers may require longer travel times from similar spatial positions compared to off-peak periods, necessitating probability fields that account for reduced transportation efficiency and increased approach timing variability. Weather conditions may affect customer movement speeds and route preferences, with adverse weather potentially requiring probability fields that account for slower movement speeds and altered spatial approach patterns as customers seek covered or more convenient access routes.

Transportation modality differences may result in fundamentally different spatial approach patterns that require separate probability field generation and analysis. Customers arriving by car may concentrate their approach patterns around parking areas and vehicular access points, while pedestrian customers may approach from public transportation stops, nearby businesses, or residential areas with different spatial distributions. Bicycle customers may utilize bike lanes or alternative routes that result in distinct approach patterns compared to vehicular or pedestrian traffic, potentially requiring specialized probability fields that account for the unique characteristics of bicycle transportation and parking requirements.

Temporal factors such as time of day and day of week may interact with other contextual variables to create complex patterns that require sophisticated probability field selection algorithms. For example, weekday morning rush hour periods may combine high traffic congestion with time-constrained customer behavior, resulting in approach patterns that differ from both weekend morning periods and weekday afternoon periods. The system may maintain probability fields that account for these interaction effects, enabling more accurate event triggering decisions that consider the combined impact of multiple contextual factors on customer arrival patterns.

With continued reference to FIG. 7, the process 700 proceeds to a step 706 for determining or selecting one or more probability fields based on the state data 704. The step 706 represents the contextual analysis phase where the system evaluates the current operational conditions and environmental factors to identify which probability field or combination of probability fields may provide the most accurate predictions for the present scenario. This selection process enables the system to adapt its event triggering decisions to the specific conditions affecting customer arrival patterns, moving beyond a single universal probability field to utilize contextual probability distributions that account for the dynamic nature of customer movement behaviors under different operational circumstances.

The step 706 utilizes the comprehensive contextual information contained within the state data 704 to make informed decisions about probability field selection that optimize event triggering accuracy for current conditions. The selection process may involve analyzing individual state parameters such as time of day, weather conditions, or transportation modality to identify probability fields that were generated from historical data collected under similar conditions. Additionally, the step 706 may consider combinations of state parameters to select probability fields that account for the interaction effects between multiple contextual factors that simultaneously influence customer arrival patterns.

As shown in FIG. 7, the step 706 results in the determination or selection of probability fields 708 that represent the collection of spatial probability distributions available for event triggering analysis under current operational conditions. The probability fields 708 demonstrate how the system maintains multiple probability distributions that correspond to different operational states and contextual scenarios, enabling adaptive event triggering that accounts for the varying conditions that affect customer movement and arrival timing patterns around pickup locations.

The probability fields 708 include a probability field 710 that represents a spatial probability distribution generated from historical data collected under specific operational conditions that may correspond to the current state parameters. The probability field 710 may have been generated from historical location data collected during similar time periods, weather conditions, or transportation scenarios that match the current operational context indicated by the state data 704. For example, the probability field 710 may represent arrival patterns observed during weekday morning periods when traffic congestion and customer time constraints create specific spatial approach patterns that differ from other operational periods.

Additionally, the probability fields 708 include a probability field 712 that represents an alternative spatial probability distribution corresponding to different operational conditions or state parameters that may be relevant to current circumstances. The probability field 712 may have been generated from historical data collected under different contextual conditions compared to the probability field 710, such as different times of day, weather patterns, or customer transportation modalities. The availability of the probability field 712 enables the system to select the most appropriate probability distribution based on current conditions or to utilize multiple probability fields in combination for enhanced prediction accuracy.

Furthermore, the probability fields 708 include a probability field 714 that represents yet another spatial probability distribution that may correspond to additional operational scenarios or state combinations that could be relevant to current event triggering decisions. The probability field 714 demonstrates the system's capability to maintain multiple contextual probability distributions that account for the full spectrum of operational conditions and environmental factors that influence customer arrival patterns. The notation “PFn” associated with the probability field 714 indicates that the system may maintain any number of probability fields corresponding to different operational states and contextual scenarios.

The system may generate temporal contextual fields for different conditions by analyzing historical location data collected during specific time periods and operational contexts to create probability distributions that reflect the unique characteristics of customer arrival patterns under those conditions. For example, the system may generate separate probability fields for morning rush hour periods, midday periods, afternoon periods, and evening periods, with each temporal probability field capturing the distinct spatial approach patterns and timing characteristics observed during those specific time windows. These temporal contextual fields enable the system to account for variations in traffic conditions, customer urgency levels, and operational factors that affect arrival patterns throughout different periods of the day.

The generation of temporal contextual fields may extend beyond daily time periods to encompass weekly patterns, seasonal variations, and special event conditions that create distinct customer arrival behaviors. The system may maintain separate probability fields for weekdays versus weekends, accounting for differences in customer demographics, traffic patterns, and operational contexts that affect arrival timing and spatial approach patterns. Seasonal probability fields may account for weather-related variations in customer movement behaviors, while special event probability fields may address the unique arrival patterns that occur during holidays, promotional periods, or local events that significantly alter normal customer traffic patterns.

Transportation modality represents another dimension for generating contextual probability fields, with the system maintaining separate probability distributions for customers arriving by different transportation methods. Driving customers may exhibit approach patterns concentrated around parking areas and vehicular access points, while walking customers may approach from public transportation stops, nearby businesses, or residential areas with different spatial distributions. Biking customers may utilize bike lanes or alternative routes that result in distinct approach patterns compared to vehicular or pedestrian traffic, requiring specialized probability fields that account for the unique characteristics of bicycle transportation and parking requirements.

The system may handle multiple trigger settings by maintaining different probability fields that correspond to various event triggering thresholds and timing requirements. For example, a restaurant may require different trigger timing for different types of orders, with simple orders requiring 30-second preparation triggers while complex orders require 90-second preparation triggers. The system may maintain separate probability fields optimized for each trigger timing threshold, enabling accurate event triggering decisions that account for the specific preparation requirements and timing constraints associated with different order types or operational scenarios.

The interpolation between different timing values for events may be accomplished through weighted analysis of multiple probability fields that correspond to different trigger thresholds or operational requirements. When current conditions or order characteristics fall between the specific scenarios represented by individual probability fields, the system may combine probability values from multiple fields to generate interpolated predictions that account for the intermediate characteristics of the current situation. This interpolation capability enables the system to provide accurate event triggering decisions even when current conditions do not exactly match the specific scenarios used to generate individual probability fields.

In cases where different probability fields represent different estimated arrival timing thresholds, the system may determine trigger decisions based on contributions or probabilities from each of the different probability fields. For example, if the probability field 710 represents 60-second arrival predictions while the probability field 712 represents 90-second arrival predictions, the system may evaluate the current customer location against both probability fields and combine the resulting probability assessments to determine the most appropriate trigger timing for current conditions. This multi-field analysis enables more nuanced event triggering decisions that account for the uncertainty and variability inherent in arrival time predictions.

The interpolation process may involve weighted averaging of probability values from multiple fields based on the relevance of each field to current operational conditions. If current conditions partially match the scenarios represented by multiple probability fields, the system may assign weights to each field based on the degree of similarity between current conditions and the historical conditions used to generate each field. The weighted combination of probability assessments enables the system to generate interpolated predictions that reflect the combined influence of multiple operational factors and contextual variables affecting customer arrival patterns.

The system may utilize machine learning algorithms or statistical analysis techniques to optimize the interpolation process and determine the most effective methods for combining probability assessments from multiple fields. The interpolation optimization may involve analyzing historical performance data to identify the weighting algorithms and combination methods that provide the most accurate event triggering predictions when multiple probability fields are relevant to current operational conditions. This optimization process enables the system to continuously improve its interpolation accuracy and adapt to the specific characteristics of different pickup locations and operational environments.

With continued reference to FIG. 7, the process 700 proceeds to a step 716 for receiving location data of the user computing device as the user computing device approaches the pickup location. The step 716 represents the real-time data collection phase where the system obtains current spatial positioning information from customers or pickup entities who are traveling toward the pickup location, providing the location coordinates that will be evaluated against the selected state-dependent probability fields to determine appropriate event triggering decisions. The location data received in the step 716 may include GPS coordinates, cellular positioning information, or other location determination technologies that provide accurate spatial positioning for analysis against the contextually appropriate probability distributions identified in the step 706.

The step 716 enables the system to collect current location information that will be processed using the probability fields 708 selected based on the state data 704, ensuring that the location evaluation utilizes the most appropriate probability distribution for current operational conditions. The location data collection process may be configured to receive updates at frequencies that optimize accuracy while managing computational and communication resources, with update intervals potentially adjusted based on the proximity of the user computing device to the pickup location and the specific characteristics of the selected probability fields. For example, when the probability field 710 indicates higher spatial variability in arrival patterns due to complex traffic conditions, the system may request more frequent location updates to capture detailed movement patterns that enable accurate probability assessments.

The location data received in the step 716 provides the spatial coordinates that will be mapped onto the selected probability fields to determine the likelihood of arrival within specified time thresholds based on historical patterns observed under similar operational conditions. The system may receive location data that includes latitude and longitude coordinates, accuracy indicators that reflect the precision of the positioning information, speed and heading data that indicate movement characteristics, and timestamp information that enables temporal analysis of customer approach patterns. This comprehensive location information enables the system to perform detailed analysis of customer positioning relative to the contextually appropriate probability distributions selected based on current operational conditions.

Following the location data collection, the process 700 advances to a step 718 for determining a time in which the user computing device is associated with a particular estimated time of arrival based at least in part on the one or more probability fields 708. The step 718 represents the predictive analysis phase where the system evaluates the received location data against the selected state-dependent probability fields to determine when the customer may arrive at the pickup location based on historical arrival patterns observed under similar operational conditions. This determination process leverages the contextual probability distributions to provide more accurate arrival predictions that account for the specific environmental and operational factors affecting customer movement patterns during current conditions.

The step 718 utilizes the location data received in the step 716 in conjunction with the probability fields 708 selected in the step 706 to perform contextual analysis that accounts for current operational conditions when determining estimated arrival timing. The determination process may involve mapping the current customer location onto the selected probability fields and evaluating the probability values associated with that spatial position to predict when the customer may reach the pickup location based on historical patterns observed under similar state conditions. For example, if the state data 704 indicates current conditions that match morning rush hour traffic patterns, the step 718 may utilize the probability field 710 that was generated from historical data collected during similar morning traffic conditions to provide arrival predictions that account for the reduced transportation efficiency and altered movement patterns typically observed during peak traffic periods.

The state-dependent probability field approach implemented in the step 718 may provide significant accuracy improvements compared to using a single universal probability field for all operational conditions. During morning rush hour periods, customers approaching from similar spatial positions may require substantially longer travel times compared to off-peak periods due to traffic congestion, altered route availability, and increased parking challenges that affect the final stages of the arrival process. By utilizing the probability field 710 that was generated specifically from historical data collected during morning rush hour conditions, the system can account for these traffic-related delays and provide more accurate arrival predictions that reflect the transportation challenges present during peak traffic periods.

Weather conditions represented in the state data 704 may significantly impact customer movement patterns in ways that warrant separate probability field analysis for accurate arrival predictions. During rainy weather conditions, customers may exhibit slower movement speeds, seek covered parking areas, and require additional time to navigate from parking locations to pickup entrances due to weather protection considerations. The step 718 may utilize the probability field 712 that was generated from historical data collected during similar weather conditions to account for these weather-related movement pattern changes, providing arrival predictions that reflect the altered spatial approach patterns and increased timing variability typically observed during adverse weather conditions.

Transportation modality differences captured in the state data 704 may result in fundamentally different spatial approach patterns that require separate probability field analysis for accurate event triggering decisions. Customers arriving by car may concentrate their approach patterns around parking areas and vehicular access points, with arrival timing heavily influenced by parking availability and traffic flow around the pickup location. In contrast, pedestrian customers may approach from public transportation stops, nearby businesses, or residential areas with different spatial distributions and timing characteristics that reflect walking speeds and pedestrian route preferences. The step 718 may select between the probability field 710 for vehicular customers and the probability field 712 for pedestrian customers based on transportation modality information in the state data 704, enabling arrival predictions that account for the distinct movement characteristics associated with different transportation methods.

The step 718 may determine estimated arrival timing by analyzing probability values from multiple regions within the selected probability fields to account for positioning uncertainty and GPS accuracy limitations that may affect the precision of location data received in the step 716. When the current customer location falls between discrete grid positions within the selected probability field, the system may interpolate probability values from adjacent spatial regions to generate arrival predictions that account for the spatial uncertainty inherent in location-based positioning systems. This interpolation approach enables more robust arrival predictions that consider the characteristics of the spatial area surrounding the customer's current position rather than relying solely on probability values associated with a single discrete grid location.

In cases where multiple probability fields within the probability fields 708 may be relevant to current operational conditions, the step 718 may combine probability assessments from the probability field 710, the probability field 712, and the probability field 714 to generate arrival predictions that account for the combined influence of multiple contextual factors affecting customer movement patterns. For example, if current conditions involve both morning rush hour traffic patterns and light rain weather conditions, the system may weight probability values from traffic-specific and weather-specific probability fields to generate arrival predictions that account for the interaction effects between traffic congestion and weather-related movement pattern changes. This multi-field analysis enables more nuanced arrival predictions that consider the complex interactions between different operational factors that simultaneously influence customer approach behaviors.

The contextual approach implemented in the step 718 may enable the system to adapt event triggering thresholds based on the characteristics of the selected probability fields and the variability in arrival patterns observed under current operational conditions. During periods when the selected probability fields indicate high variability in customer arrival timing due to traffic congestion or weather conditions, the system may adjust trigger thresholds to account for increased uncertainty in arrival predictions. Conversely, during periods when the selected probability fields indicate consistent and predictable arrival patterns, the system may utilize more precise trigger thresholds that enable optimal coordination of preparation activities with customer arrival timing.

The determination process in the step 718 may account for the confidence levels associated with different probability fields within the probability fields 708, enabling the system to weight arrival predictions based on the statistical reliability of the historical data used to generate each probability field. Probability fields generated from extensive historical datasets collected under well-defined operational conditions may receive higher confidence weights in the arrival prediction calculations, while probability fields based on limited historical data or highly variable conditions may receive lower confidence weights. This confidence-weighted approach enables the system to generate arrival predictions that reflect the statistical reliability of the underlying probability distributions and account for variations in data quality and consistency across different operational scenarios.

The probabilistic event triggering system may be implemented through a comprehensive method that systematically converts historical location data into actionable event triggers for pickup locations. This method addresses the fundamental challenge of transforming discrete location observations collected from multiple customer journeys into reliable operational decisions that enable businesses to coordinate preparation activities and other responses with precise timing based on statistical analysis of customer arrival patterns. The method provides a structured approach for processing historical location data through discretization, probability field generation, and real-time evaluation processes that enable accurate event triggering based on spatial probability analysis rather than conventional distance-based or time-based estimation techniques.

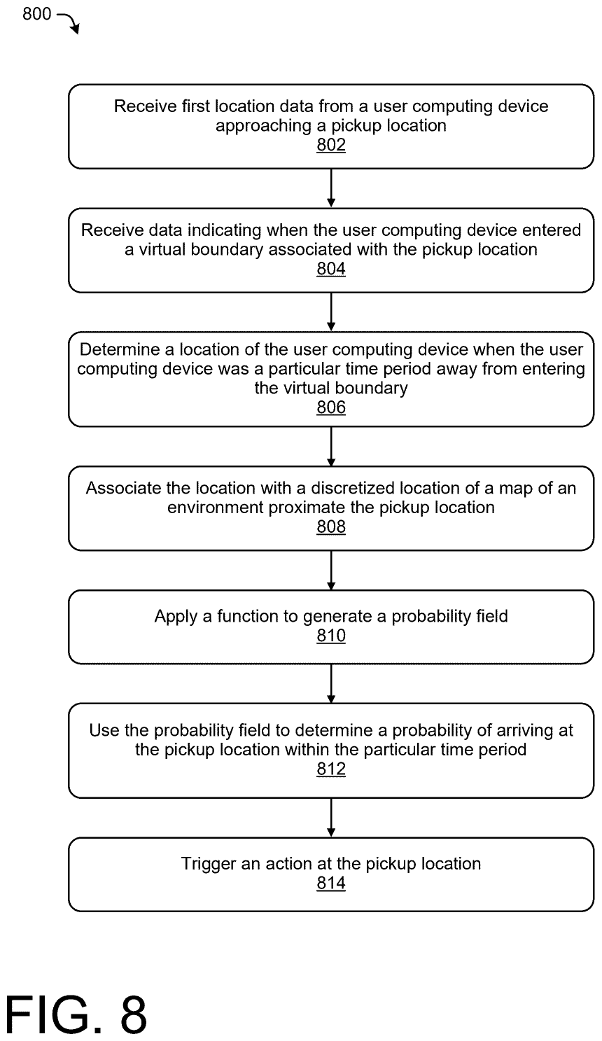

Referring to FIG. 8, the system implements a process 800 that demonstrates the complete workflow for probabilistic event triggering based on location data and virtual boundaries. The process 800 provides a systematic methodology for converting location observations into discrete spatial data, generating probability fields from aggregated historical patterns, and utilizing these probability distributions to make informed event triggering decisions based on current customer positions. The process 800 enables businesses to transition from reactive operational approaches that respond to customer arrivals after they occur to proactive approaches that anticipate customer arrivals and initiate preparation activities at optimal timing based on statistical analysis of historical movement patterns.

The process 800 addresses the limitations of conventional arrival prediction systems by providing a data-driven approach that leverages spatial discretization and probability modeling to predict arrival times and trigger appropriate actions at pickup locations. Unlike traditional systems that rely on basic mapping services and fixed timing assumptions, the process 800 utilizes comprehensive historical datasets to build predictive models that account for site-specific factors, multiple entrance points, and contextual variables that influence customer arrival patterns. The method enables businesses to achieve significant improvements in operational timing accuracy while reducing waste, optimizing resource allocation, and enhancing customer satisfaction through more precise coordination of service delivery activities.

The process 800 demonstrates how historical location data collected from user computing devices approaching pickup locations can be systematically processed to create probability-based event triggering systems that provide substantial accuracy improvements over conventional ETA prediction methods. The method incorporates virtual boundary detection, spatial discretization, probability field generation, and real-time evaluation components that work together to transform raw location observations into actionable operational decisions. The comprehensive approach enables the system to account for the complex spatial and temporal factors that influence customer arrival patterns while providing a scalable framework that can be adapted to different types of pickup locations and operational requirements.

With continued reference to FIG. 8, the process 800 begins with a step 802 for receiving first location data from a user computing device, the first location data representing locations of the user computing device as the user computing device approaches a pickup location. The step 802 represents the foundational data collection phase where the system establishes monitoring of customer movement patterns as they travel toward pickup destinations, providing the spatial positioning information that forms the basis for all subsequent probability analysis and event triggering decisions. The first location data collection process enables the system to capture comprehensive movement trajectories that document customer approach behaviors and spatial progression patterns throughout their journey to pickup locations.

The step 802 may involve receiving location data that includes GPS coordinates, cellular positioning information, Wi-Fi triangulation data, or other location determination technologies that provide accurate spatial positioning for tracking customer movement as they approach pickup locations. The first location data may include latitude and longitude coordinates that specify the precise geographic position of the user computing device at various points during the approach journey, enabling the system to map customer movement patterns onto geographic coordinate systems for spatial analysis. Additionally, the first location data may include accuracy indicators that reflect the precision of the positioning information, speed and heading data that indicate movement characteristics and direction of travel, and timestamp information that enables temporal analysis of customer approach patterns and movement progression over time.

In some examples, the step 802 may receive first location data at configurable intervals that optimize the balance between spatial resolution and system resource utilization, with location update frequencies potentially adjusted based on the proximity of the user computing device to the pickup location and the specific accuracy requirements for probability field generation. The system may request location updates approximately every two seconds when the user computing device is at moderate distances from the pickup location, providing sufficient spatial sampling to capture movement patterns while managing communication bandwidth and battery consumption on mobile devices. As the user computing device approaches closer to the pickup location, the system may increase the frequency of location updates to capture more detailed movement patterns during the critical final approach phase where precise positioning becomes more important for accurate event triggering decisions.

The first location data received in the step 802 may represent multiple spatial positions collected as the user computing device progresses along various approach routes toward the pickup location, capturing the diversity of customer movement patterns that result from different starting locations, route preferences, traffic conditions, and transportation modalities. The system may collect first location data from customers approaching from residential areas, commercial districts, transportation hubs, or other pickup locations, documenting the full spectrum of spatial approach patterns that contribute to comprehensive probability field generation. This diverse location data collection enables the system to build probability distributions that account for the various ways customers may approach pickup locations rather than assuming uniform or simplified movement patterns.

The step 802 addresses the challenge of collecting representative location data that captures the natural variations in customer approach behaviors while filtering out anomalous observations that may not represent typical movement patterns. The system may implement data validation processes that identify and handle location data points that exhibit unusual characteristics, such as extremely rapid position changes that may indicate GPS errors, stationary periods that may represent temporary stops or delays, or location jumps that may result from cellular positioning inaccuracies. By applying appropriate data validation and filtering techniques during the step 802, the system ensures that the first location data used for probability field generation represents realistic and representative customer movement patterns.

Following the location data collection, the process 800 proceeds to a step 804 for receiving data indicating when the user computing device entered a virtual boundary associated with the pickup location. The step 804 represents the arrival detection phase where the system identifies the precise moment when customers reach the pickup location premises, providing the temporal reference point that enables the correlation of spatial positions with arrival timing for probability field generation. The virtual boundary entry detection process establishes the ground truth arrival timing that serves as the foundation for building statistical relationships between customer locations and arrival predictions throughout the surrounding geographic area.

The step 804 utilizes the virtual boundary as a geofence or polygonal area that defines the perimeter around the pickup location for detecting customer arrivals and establishing consistent arrival timing references across different customer journeys. Unlike conventional systems that rely on single-point routing to specific coordinates, the virtual boundary may encompass the entire pickup location premises including multiple entrance points, parking areas, drive-through lanes, and pedestrian access routes that customers may use to reach the pickup location. This comprehensive boundary definition enables the system to detect arrivals regardless of which specific entrance or access point customers utilize, providing more accurate and consistent arrival timing detection compared to single-point arrival systems.

The data indicating when the user computing device entered the virtual boundary may include timestamp information that specifies the precise time when the boundary crossing occurred, location coordinates that identify the specific spatial position where the boundary entry was detected, and contextual information such as the direction of approach or the specific boundary segment that was crossed. This comprehensive boundary entry data enables the system to establish accurate temporal correlations between customer locations collected during the approach phase and the actual arrival timing at the pickup location, providing the statistical foundation for generating probability fields that predict arrival timing based on spatial positioning.

In some examples, the step 804 may detect virtual boundary entry through continuous monitoring of the user computing device location relative to the defined boundary perimeter, triggering boundary entry notifications when the location coordinates indicate that the user computing device has crossed from outside the boundary to inside the boundary area. The boundary detection process may account for GPS accuracy limitations and positioning uncertainty by implementing appropriate tolerance zones or confirmation algorithms that ensure reliable boundary entry detection while minimizing false positive or false negative boundary crossing notifications. The system may require multiple consecutive location readings within the boundary area before confirming boundary entry, or may implement hysteresis algorithms that prevent rapid boundary entry and exit notifications due to GPS positioning variations near the boundary perimeter.

The step 804 enables the system to track customer movement patterns from initial approach positions through final arrival at the pickup location, documenting the complete spatial and temporal progression that forms the basis for probability field generation. For example, the system may track a customer who begins their approach from a location several blocks away from the pickup location, progresses through various intermediate positions as they navigate traffic and route obstacles, and ultimately enters the virtual boundary at a specific time that establishes the arrival reference point. This complete movement tracking enables the system to correlate each spatial position along the approach route with the time remaining until boundary entry, building comprehensive datasets that associate specific geographic locations with consistent arrival timing patterns.

The virtual boundary entry detection implemented in the step 804 may accommodate different types of pickup locations and operational scenarios by supporting configurable boundary definitions that align with specific site characteristics and operational requirements. For restaurants with drive-through facilities, the virtual boundary may encompass both the drive-through lane entrance and the parking area entrance to detect arrivals regardless of whether customers choose drive-through or walk-in service options. For retail locations with multiple entrances, the virtual boundary may include all customer access points to ensure consistent arrival detection regardless of which entrance customers utilize. For curbside pickup locations, the virtual boundary may focus on designated pickup zones while excluding general parking areas that may not represent actual service arrivals.

The combination of the step 802 and the step 804 enables the system to establish comprehensive datasets that correlate customer spatial positions throughout their approach journey with precise arrival timing at pickup locations, providing the statistical foundation for generating probability fields that predict arrival timing based on current customer locations. The first location data collected during the approach phase provides the spatial reference points that will be associated with specific time thresholds before boundary entry, while the boundary entry detection provides the temporal reference that enables the calculation of time-to-arrival values for each spatial position. This coordinated data collection process enables the system to build probability distributions that reflect the likelihood of customers at specific spatial positions reaching the pickup location within designated time thresholds based on historical arrival patterns observed under similar conditions.

With continued reference to FIG. 8, the process 800 proceeds to a step 806 for determining, based on the first location data, a location of the user computing device when the user computing device was a particular time period away from the user computing device entering the virtual boundary. The step 806 represents the temporal-spatial correlation phase where the system analyzes the collected location trajectory data to identify specific geographic positions that correspond to predetermined time thresholds before arrival at the pickup location. This determination process enables the system to establish spatial reference points that can be used to build probability fields for predicting when future customers at similar locations may arrive at the pickup location based on historical arrival timing patterns.

The step 806 utilizes the first location data collected during the step 802 in conjunction with the virtual boundary entry timing detected during the step 804 to perform retrospective analysis that correlates specific geographic positions with arrival timing patterns. The determination process may involve analyzing the temporal progression of location data points collected as the user computing device approached the pickup location, calculating the time difference between each recorded location and the moment of virtual boundary entry to identify which spatial positions correspond to specific time thresholds before arrival. For example, the system may analyze the first location data to determine that when the user computing device was at a specific geographic coordinate, the user computing device was exactly 60 seconds away from entering the virtual boundary based on the actual timing of the subsequent boundary crossing event.

In some examples, the step 806 may determine locations associated with various time thresholds such as 30 seconds, 60 seconds, 90 seconds, or 120 seconds before virtual boundary entry to accommodate different operational requirements and event triggering scenarios. A restaurant may utilize the 60-second threshold for initiating food preparation activities, ensuring that cooking processes begin at the optimal time to have orders ready when customers arrive at the pickup location. A pharmacy may utilize the 90-second threshold for retrieving prescription medications from storage areas, providing sufficient time for staff to locate and prepare orders while minimizing customer wait times upon arrival.

The determination process implemented in the step 806 may account for variations in customer approach patterns based on contextual factors such as time of day, traffic conditions, or transportation modality that influence movement speeds and arrival timing. During peak traffic periods, customers may require longer travel times to cover the same geographic distance compared to off-peak periods, resulting in different spatial positions being associated with the same time threshold before virtual boundary entry. The system may determine that during morning rush hour conditions, customers located at a position 500 meters from the pickup location may be 60 seconds away from virtual boundary entry, while during off-peak periods, customers at the same spatial position may be only 45 seconds away due to improved traffic flow and reduced transportation delays.

The step 806 may determine multiple historical locations associated with the particular time period to build comprehensive datasets that account for the natural variations in customer approach patterns and movement behaviors. For a 60-second time threshold, the system may identify numerous spatial positions where different customers were historically located when they were 60 seconds away from entering the virtual boundary, capturing the diversity of approach routes, traffic conditions, and movement speeds that contribute to arrival timing variations. This comprehensive location determination enables the system to build robust probability distributions that reflect the full spectrum of spatial positions associated with specific arrival timing thresholds rather than relying on single-point or simplified spatial assumptions.

In some instances, the step 806 may determine locations by analyzing the first location data to identify the spatial position that most closely corresponds to the particular time period before virtual boundary entry, accounting for the discrete nature of location data collection and the potential for timing variations between consecutive location updates. When location data is collected at regular intervals such as every two seconds, the system may interpolate between consecutive location points to estimate the precise spatial position where the user computing device was located at the exact moment corresponding to the particular time period before boundary entry. This interpolation approach enables more accurate spatial determination that accounts for the continuous nature of customer movement between discrete location observation points.

The determination process may utilize various analytical techniques to correlate spatial positions with arrival timing, including linear interpolation between consecutive location points, curve fitting algorithms that model customer movement trajectories, or statistical analysis methods that account for positioning uncertainty and GPS accuracy limitations. When the first location data indicates that a customer was at one location 65 seconds before boundary entry and at another location 55 seconds before boundary entry, the system may interpolate between these positions to estimate where the customer was located exactly 60 seconds before boundary entry. This interpolation capability enables the system to determine spatial positions associated with specific time thresholds even when the discrete location sampling intervals do not precisely align with the desired timing thresholds.

The step 806 may account for different transportation modalities and approach patterns that result in varying spatial distributions for the same time threshold before virtual boundary entry. Customers arriving by car may be located at different spatial positions 60 seconds before boundary entry compared to customers arriving on foot, reflecting the different movement speeds and route characteristics associated with vehicular versus pedestrian transportation. The system may determine separate sets of locations associated with the particular time period for different transportation modalities, enabling the generation of transportation-specific probability fields that account for the distinct spatial approach patterns exhibited by customers using different methods of transportation to reach pickup locations.

The location determination process implemented in the step 806 provides the spatial foundation for probability field generation by identifying the geographic positions that serve as reference points for building statistical distributions of arrival likelihood. Each determined location represents a data point that contributes to the probability analysis, enabling the system to calculate the likelihood of customers at similar spatial positions arriving at the pickup location within the particular time period based on historical patterns. The comprehensive collection of determined locations associated with specific time thresholds enables the system to build probability fields that reflect the spatial distribution of arrival likelihood across the geographic area surrounding pickup locations.

With continued reference to FIG. 8, the process 800 proceeds to a step 808 for associating the location with a discretized location of a map of an environment proximate the pickup location. The step 808 represents the spatial transformation phase where continuous geographic coordinates determined in the step 806 are converted into structured grid coordinates that enable systematic probability analysis and spatial pattern recognition. This discretization process provides the foundation for generating probability fields by organizing location data into uniform spatial units that can be consistently analyzed across multiple customer journeys and different pickup locations.

The step 808 utilizes the location determined in the step 806, which represents the spatial position where the user computing device was located when it was the particular time period away from entering the virtual boundary, and maps this continuous geographic coordinate onto a discretized spatial framework. The discretization process involves subdividing the geographic area surrounding the pickup location into uniform grid cells or regions, where each cell represents a discrete spatial unit that can be assigned probability values based on historical location data patterns. The step 808 enables the system to aggregate location observations from multiple customers within the same spatial regions, building statistical datasets that reflect the frequency and timing of customer presence at different positions around the pickup location.

In some examples, the step 808 may utilize a configurable grid resolution where each grid cell represents a discrete spatial unit with dimensions such as 5 meters by 5 meters, providing sufficient spatial granularity for accurate probability calculations while maintaining manageable data processing requirements. The grid resolution may be adjusted based on the specific characteristics of different pickup locations and operational requirements, with dense urban environments potentially benefiting from higher resolution grids with smaller cell sizes such as 2-meter or 3-meter grid cells to capture fine-grained spatial variations in customer approach patterns. Conversely, pickup locations in suburban or rural areas with more straightforward access routes may utilize larger grid cells such as 10-meter or 15-meter cells to optimize computational efficiency while maintaining adequate spatial precision for accurate event triggering.

The association process implemented in the step 808 may involve coordinate transformation algorithms that convert latitude and longitude coordinates into pixel coordinates or grid indices within the discretized spatial framework. This transformation enables efficient probability lookups by translating continuous geographic coordinates into discrete grid positions that can be rapidly evaluated against stored probability field data. The coordinate transformation process may account for geographic projection considerations and coordinate system variations to ensure accurate spatial mapping across different geographic regions and coordinate reference systems.

The step 808 enables the system to focus on location characteristics rather than individual user profiling or driver behavior analysis by organizing spatial data into uniform grid cells that reflect the inherent characteristics of specific geographic positions around pickup locations. Each discretized location serves as a data collection point where historical arrival patterns are aggregated to build statistical datasets for probability field generation, with multiple customer journeys that pass through the same grid cell contributing to the probability calculations for that specific spatial region. This aggregation approach provides statistical robustness by combining observations from multiple customers, reducing the impact of individual variations and outliers while identifying consistent spatial patterns that can be used for accurate event triggering.

Following the spatial discretization, the process 800 advances to a step 810 for applying a function to generate a probability field. The step 810 represents the probability distribution generation phase where discrete historical location data points are transformed into continuous spatial probability distributions that enable accurate prediction of customer arrival patterns. This transformation process addresses the inherent spatial discontinuity that results from collecting location data at specific discrete positions by applying mathematical functions that create smooth probability transitions across the discretized grid established in the step 808.

The step 810 utilizes a blurring function that transforms discrete location observations into smooth, continuous probability distributions across the discretized spatial framework. The blurring function addresses the inherent spatial uncertainty in location data by spreading probability values from specific data points to adjacent grid cells, creating generalized probability regions that account for GPS accuracy limitations and natural variations in customer movement patterns. By applying the blurring function to aggregated location data collected at discrete grid positions, the system generates probability fields that provide continuous spatial coverage rather than isolated probability points, enabling more robust event triggering decisions that account for positioning uncertainty and interpolation across multiple grid locations.

In some examples, the blurring function may comprise a Gaussian blur function that applies a mathematical kernel to the discrete location observations to create smooth probability transitions across the spatial grid. The Gaussian blur function utilizes configurable parameters including kernel size and standard deviation that can be tuned for accuracy optimization based on site-specific characteristics and historical performance data. The kernel size parameter determines the spatial extent of the blurring effect, controlling how far probability values are spread from their original observation points, while the standard deviation parameter controls the intensity distribution of the blurring effect, determining how probability values are weighted across the kernel region.

The Gaussian blur kernel may be defined mathematically using a two-dimensional Gaussian distribution that assigns weights to surrounding grid cells based on their distance from the original observation point. Grid cells closer to the original observation receive higher weights in the blurring calculation, while grid cells farther away receive progressively lower weights according to the Gaussian distribution curve. This weighting approach creates smooth probability transitions that reflect the spatial uncertainty inherent in location-based positioning systems while preserving the statistical significance of the original observation points.

Alternative blurring functions may be utilized in the step 810 to accommodate different spatial characteristics and operational requirements of various pickup locations. A uniform blur function may apply equal weighting to all grid cells within a specified radius of the original observation point, creating probability distributions with sharp boundaries that may be appropriate for pickup locations with well-defined approach patterns and minimal spatial uncertainty. A triangular blur function may apply linearly decreasing weights based on distance from the original observation point, providing probability distributions with intermediate smoothness characteristics between uniform and Gaussian blurring approaches.

An exponential blur function may apply exponentially decreasing weights based on distance from the original observation point, creating probability distributions with rapid decay characteristics that concentrate probability values near the original observations while providing limited spatial spreading to adjacent areas. A custom blur function may be designed based on the specific spatial characteristics of individual pickup locations, incorporating factors such as road network topology, traffic flow patterns, or site-specific obstacles that influence customer approach behaviors and spatial movement patterns around the pickup location.

The step 810 generates a probability field where a probability of the probability field indicates a probability of a computing device at a particular location entering the virtual boundary within the particular time period. The probability field provides comprehensive spatial coverage that enables the system to evaluate customer positions anywhere within the coverage area and determine the likelihood of arrival within the specified time threshold based on historical arrival patterns observed from similar spatial positions. Each location within the probability field is assigned a probability value that represents the historical likelihood of customers at that position reaching the pickup location within the designated time threshold, such as 60 seconds or another configurable trigger timing.

The probability values within the probability field may range from zero to one, where higher probability values indicate spatial positions where historical data demonstrates consistent customer arrivals within the specified time period, and lower probability values indicate positions where customers historically required longer times to reach the pickup location. For example, a probability value of 0.8 at a specific spatial position may indicate that 80% of customers who were historically located at that position arrived at the pickup location within the particular time period, while a probability value of 0.3 may indicate that only 30% of customers from that position arrived within the time threshold.

The probability field generated in the step 810 may be stored as an image format that enables efficient retrieval of probability values through coordinate transformation and pixel-based lookup operations. This image-based storage approach allows the system to rapidly translate a customer's current location coordinates into pixel coordinates within the stored probability field image, enabling immediate access to the corresponding probability value without requiring complex mathematical calculations during real-time event triggering evaluations. The image format storage provides computational efficiency by pre-computing the probability distributions and storing them in a format that supports rapid spatial queries and probability retrievals.

In some examples, the historical data collected through the steps 802, 804, and 806 may be used as ground truth data to train a machine learning model that outputs a classification system for spatial probability analysis. The machine learning model may be trained using the historical location data as input features and the actual arrival timing outcomes as ground truth labels, enabling the model to learn the complex relationships between spatial positions and arrival likelihood that may not be captured through traditional blurring function approaches. The classification system may categorize different spatial positions into discrete probability classes that correspond to different likelihood levels of customers at those locations arriving within the particular time period.

The machine learning model may utilize various algorithms such as decision trees, random forests, support vector machines, or neural networks to learn the spatial patterns and arrival correlations present in the historical data. Different classifications output by the model may correspond to probability ranges such as high probability (0.7-1.0), medium probability (0.4-0.7), and low probability (0.0-0.4), where each classification indicates the likelihood of a computing device at that location arriving within the particular estimated time of arrival threshold. The classification approach may provide more nuanced probability assessments that account for complex spatial relationships and contextual factors that influence customer arrival patterns beyond simple distance-based or blurring function calculations.

The machine learning model may be trained using features derived from the historical location data including spatial coordinates, distance to pickup location, direction of approach, time of day, day of week, weather conditions, and transportation modality information. The model may learn to identify spatial patterns and contextual relationships that correlate with consistent arrival timing, enabling the generation of probability classifications that reflect the complex interactions between multiple factors affecting customer movement and arrival behaviors. The classification system may provide discrete probability categories that simplify event triggering decisions while maintaining the accuracy benefits of comprehensive historical data analysis.

The trained machine learning model may output probability classifications that can be mapped onto the discretized spatial grid to create probability fields with discrete probability zones rather than continuous probability distributions. Each grid cell within the discretized spatial framework may be assigned a probability classification based on the model's analysis of historical data associated with that spatial region, creating probability fields that reflect the learned relationships between spatial positions and arrival likelihood. This classification-based approach may provide computational efficiency benefits by reducing the complexity of probability calculations while maintaining the predictive accuracy derived from comprehensive historical data analysis.

With continued reference to FIG. 8, the process 800 proceeds to a step 812 for using the probability field to determine a probability of arriving at the pickup location within the particular time period. The step 812 represents the real-time evaluation phase where the system utilizes the probability field generated in the step 810 to assess the likelihood of customer arrival based on current location data, enabling informed decision-making about when to initiate operational actions at pickup locations. This probability determination process transforms the historical spatial analysis embodied in the probability field into actionable assessments that reflect the likelihood of customers reaching the pickup location within the specified time threshold based on their current geographic position.

The step 812 utilizes the probability field generated through the blurring function application in the step 810 to evaluate current customer positions and determine arrival likelihood based on the comprehensive historical analysis of customer movement patterns. The probability determination process may involve mapping current customer location coordinates onto the probability field and retrieving the probability value associated with that spatial position, providing an immediate assessment of arrival likelihood based on historical patterns observed from similar geographic locations. The system may translate real-time GPS coordinates or other location data into grid coordinates within the probability field framework, enabling rapid probability lookups that support real-time event triggering decisions.

In some examples, the step 812 may determine the probability based on a first probability associated with a first discrete region of the probability field and a second probability associated with a second discrete region of the probability field that is different than the first discrete region. This multi-region analysis enables interpolation and weighted evaluation across multiple grid locations to account for positioning uncertainty that may result from GPS accuracy limitations or natural variations in location reporting. When a customer's current location falls between discrete grid positions within the probability field, the system may analyze probability values from adjacent spatial regions to generate arrival assessments that consider the spatial characteristics of the area surrounding the customer's current position rather than relying solely on a single discrete probability value.

The multi-region probability determination may involve weighted averaging of probability values from multiple grid cells based on the proximity of the customer's current location to each discrete region within the probability field. For example, if a customer's current location is positioned between four adjacent grid cells within the probability field, the system may calculate weighted probability contributions from each of the four cells based on the spatial distance between the customer's location and the center of each grid cell. The first discrete region may contribute a probability value of 0.7 with a weighting factor of 0.4 based on its proximity to the customer's location, while the second discrete region may contribute a probability value of 0.6 with a weighting factor of 0.3, enabling the system to generate an interpolated probability assessment that accounts for the spatial characteristics of multiple regions surrounding the customer's position.

The interpolation approach implemented in the step 812 may utilize various mathematical techniques such as bilinear interpolation, inverse distance weighting, or spline interpolation to combine probability values from multiple discrete regions and generate smooth probability assessments that account for positioning uncertainty. Bilinear interpolation may calculate probability values based on the linear interpolation between probability values in adjacent grid cells, providing smooth transitions that reflect the continuous nature of customer movement between discrete observation points. Inverse distance weighting may assign higher weights to discrete regions that are closer to the customer's current location and lower weights to regions that are farther away, creating probability assessments that emphasize the spatial characteristics most relevant to the customer's current position.

The step 812 may account for GPS accuracy limitations and positioning uncertainty by analyzing probability values from discrete regions within a specified radius of the customer's reported location, ensuring that probability determinations remain robust even when location data exhibits typical accuracy variations. When GPS accuracy indicators suggest positioning uncertainty of 10 meters, the system may analyze probability values from all discrete regions within a 10-meter radius of the reported location, generating probability assessments that account for the potential range of actual customer positions. This uncertainty-aware approach enables more reliable probability determinations that maintain accuracy even when location data exhibits the positioning variations commonly observed in mobile device GPS systems.

The probability determination process may incorporate confidence weighting based on the statistical reliability of historical data used to generate different regions of the probability field, enabling the system to emphasize probability values derived from robust historical datasets while appropriately weighting regions with limited historical observations. Discrete regions with extensive historical data from numerous customer journeys may receive higher confidence weights in the probability calculation, while regions with limited historical observations may receive lower confidence weights that reflect the reduced statistical reliability of probability values in those areas. This confidence-weighted approach enables the system to generate probability assessments that reflect the quality and reliability of the underlying historical data used to build the probability field.

Following the probability determination, the process 800 advances to a step 814 for triggering an action at the pickup location based on the probability meeting or exceeding a threshold probability. The step 814 represents the operational response phase where the system initiates specific actions that coordinate preparation activities, staff notifications, and other operational responses based on the probabilistic assessment of customer arrival timing. The step 814 transforms the statistical analysis of customer location and probability evaluation into concrete operational actions that enable businesses to optimize their service delivery timing and operational efficiency based on data-driven predictions of customer arrival patterns.

The step 814 may compare the probability determined in the step 812 against configurable threshold values that correspond to the operational requirements and risk tolerance of different businesses and pickup locations. For example, a restaurant that prioritizes food freshness may configure a threshold probability of 0.8, triggering food preparation activities only when there is an 80% likelihood of customer arrival within the specified time period based on historical patterns. A business with more flexible preparation timing may utilize a lower threshold probability of 0.6, triggering actions earlier in the customer approach process to provide additional preparation time while accepting a higher risk of premature action triggering.

The threshold probability values used in the step 814 may be dynamically adjusted based on contextual factors such as current order volume, staffing levels, or operational capacity that affect the business's ability to respond to customer arrivals. During peak operational periods when preparation resources are constrained, the system may increase threshold probability values to ensure that actions are triggered only when customer arrival is highly likely, minimizing the risk of resource allocation to customers who may not arrive within the expected timeframe. Conversely, during low-volume periods when preparation resources are readily available, the system may decrease threshold probability values to trigger actions earlier and provide enhanced customer service through reduced wait times upon arrival.

The actions triggered in the step 814 may include preparing an order, which involves initiating food preparation activities, retrieving prescription medications, gathering retail items, or beginning other preparation processes that align with the predicted customer arrival timing. The order preparation action enables businesses to coordinate their preparation activities with customer arrival patterns, reducing wait times while minimizing waste from premature preparation or overcooking. For restaurants, the order preparation action may involve beginning cooking processes for perishable items, heating preparation equipment, or assembling non-perishable components of orders to optimize preparation timing and food quality upon customer arrival.

Additionally, the triggered actions may include notifying staff, which involves sending alerts to employees responsible for order fulfillment, customer service, or operational coordination to inform them of impending customer arrivals. The staff notification action enables businesses to optimize their workforce allocation and ensure that appropriate personnel are available and prepared to serve customers when they arrive at the pickup location. The notification system may provide staff with information about the specific order details, customer preferences, estimated arrival timing, and any special preparation requirements that facilitate efficient service delivery and enhanced customer experience.

The step 814 may trigger preparing parking actions that involve coordinating parking space availability, directing traffic flow, or managing curbside pickup areas to accommodate incoming customers. The parking preparation action addresses the logistical challenges associated with customer arrival management, particularly in busy locations where parking availability and traffic flow coordination can significantly impact customer experience and operational efficiency. The system may coordinate with parking management systems, direct staff to reserve specific parking spaces, or activate signage systems that guide customers to appropriate pickup areas based on their order type and arrival timing.

Furthermore, the triggered actions may include sending a notification to customers, which involves communicating arrival confirmations, preparation status updates, or pickup instructions that enhance the customer experience and coordinate the final stages of the service delivery process. The customer notification action enables businesses to maintain communication with customers throughout the arrival process, providing transparency about preparation status and facilitating smooth coordination of the pickup interaction. Customer notifications may include messages such as “Your order is being prepared” when the probability threshold is exceeded, or “Your order is ready for pickup” when preparation activities are completed.

The step 814 may also trigger updating status actions that involve modifying order management systems, inventory tracking, or operational dashboards to reflect the current status of customer arrivals and preparation activities. The status update action ensures that all relevant systems and personnel have current information about order progress and customer arrival status, enabling coordinated operational responses and accurate tracking of service delivery performance. Status updates may include modifying order queue positions, updating preparation timelines, or logging customer arrival predictions for performance analysis and system optimization.

The probabilistic event triggering system implemented through the process 800 achieves significant accuracy improvements compared to conventional ETA prediction systems, reducing error for event triggering to less than 10 seconds compared to traditional map providers that typically exhibit errors of 30 to 120 seconds. This substantial improvement in timing precision results from the comprehensive historical analysis approach that accounts for site-specific factors, multiple entrance points, and contextual variables that conventional mapping services cannot accommodate. The accuracy improvement enables businesses to trigger preparation activities with much greater precision, reducing food waste, preventing overcooking, and minimizing customer wait times while optimizing operational efficiency and resource allocation.

The enhanced accuracy achieved through the process 800 represents a significant advancement over traditional distance-based or time-based estimation methods that fail to account for the complex spatial and temporal factors affecting customer arrival patterns at pickup locations. By leveraging comprehensive historical datasets and sophisticated probability field generation techniques, the system provides event triggering capabilities that enable businesses to coordinate their operational activities with unprecedented precision, resulting in improved customer satisfaction, reduced operational waste, and enhanced overall efficiency in service delivery operations.

The probabilistic event triggering method may incorporate additional features that enhance the accuracy and adaptability of the system through various data processing and analysis techniques. These additional features enable the system to continuously improve its predictive capabilities while adapting to different operational conditions and requirements that may affect customer arrival patterns at pickup locations. The enhanced functionality provides businesses with more sophisticated tools for coordinating operational activities based on comprehensive analysis of customer movement behaviors and arrival timing patterns.

In some examples, the probability field for the pickup location may be generated based on time of arrival data associated with the pickup location. The time of arrival data provides the temporal foundation for correlating spatial positions with arrival timing patterns, enabling the system to build probability distributions that reflect the likelihood of customers reaching the pickup location within specified time thresholds based on their current geographic position. The time of arrival data may include historical records of when customers actually entered the virtual boundary associated with the pickup location, providing ground truth timing information that serves as the reference for calculating time-to-arrival values for different spatial positions around the pickup location.

The time of arrival data may be collected continuously as customers approach and arrive at pickup locations, building comprehensive datasets that capture the temporal characteristics of customer arrival patterns under various operational conditions. The system may record precise timestamps when customers cross the virtual boundary, correlating these arrival times with the location data collected during the approach phase to establish statistical relationships between spatial positions and arrival timing. For example, the time of arrival data may indicate that customers who were located at a specific geographic coordinate historically arrived at the pickup location an average of 58 seconds later, with a standard deviation of 12 seconds, enabling the system to calculate probability values that reflect both the average timing and the variability in arrival patterns from that spatial position.

The generation of the probability field based on time of arrival data may involve statistical analysis techniques that account for variations in customer arrival timing and identify spatial patterns that correlate with consistent arrival behaviors. The system may analyze the time of arrival data to determine which spatial positions exhibit reliable arrival timing patterns and which positions demonstrate higher variability that may affect the accuracy of probability calculations. Spatial positions with consistent arrival timing patterns may receive higher probability values in the probability field, while positions with highly variable arrival timing may receive lower probability values that reflect the increased uncertainty in arrival predictions from those locations.

In some instances, the method may include receiving additional location data representing additional locations and arrival times of other user computing devices associated with the pickup location. The additional location data enables the system to continuously expand its historical dataset by incorporating new observations from ongoing customer interactions, providing fresh data that reflects current operational conditions and customer behavior patterns. The additional location data may include location coordinates, timestamps, and arrival timing information collected from recent customer journeys, enabling the system to maintain current and relevant datasets that account for evolving conditions around pickup locations.

The method may further include generating an updated probability field based at least in part on the probability field, the additional location data, and a Bayesian algorithm. The Bayesian algorithm provides a mathematically robust framework for incorporating new observations into existing probability distributions without requiring complete reprocessing of historical datasets. The Bayesian approach treats the existing probability field as a prior distribution representing current beliefs about spatial arrival patterns, then combines this prior with new evidence in the form of the additional location data to generate updated posterior distributions that reflect both historical knowledge and recent observations.

The Bayesian algorithm enables continuous learning and adaptation of the probability field by providing a cyclical updating process where the posterior distribution from each update cycle automatically becomes the prior for subsequent updates. This approach allows the system to continuously refine probability field accuracy by incorporating new location data and arrival timing observations while preserving the accumulated knowledge from extensive historical datasets. The Bayesian updating process naturally weights the influence of new data based on the consistency with existing patterns, enabling the system to adapt to changing conditions while maintaining statistical stability based on comprehensive historical analysis.

The updated probability field generated through the Bayesian algorithm may reflect seasonal variations, changing traffic patterns, or evolving customer behavior patterns that affect arrival timing around pickup locations. For example, if the additional location data indicates that customers are consistently arriving faster from certain spatial positions due to improved traffic flow or infrastructure changes, the Bayesian algorithm may increase the probability values associated with those positions in the updated probability field. Conversely, if new data indicates slower arrival patterns from specific areas due to construction activities or increased traffic congestion, the algorithm may decrease the corresponding probability values to reflect the changed conditions.

In some examples, the probability field may be one of a plurality of probability fields, and the probability field may be determined based at least in part on contextual factors that influence customer arrival patterns. The plurality of probability fields enables the system to maintain separate probability distributions that correspond to different operational conditions and environmental factors, allowing for more accurate event triggering decisions that account for the varying circumstances that affect customer movement behaviors around pickup locations.

The probability field may be determined based at least in part on a time of day, recognizing that customer arrival patterns may vary significantly between different periods of the day due to traffic conditions, customer urgency levels, and operational factors that affect transportation efficiency. Morning rush hour periods may exhibit different spatial distributions and timing characteristics compared to mid-afternoon periods, when traffic congestion may be reduced and customers may have more flexible timing constraints. The system may maintain separate probability fields for different time periods, such as morning hours, midday hours, afternoon hours, and evening hours, enabling the selection of the most appropriate probability distribution based on current temporal conditions.

Additionally, the probability field may be determined based at least in part on a day of the week, accounting for weekly patterns in customer behavior and traffic conditions that may affect arrival timing and spatial approach patterns. Customer arrival behaviors on weekdays may differ substantially from weekend patterns due to variations in traffic volume, customer demographics, and operational contexts that influence transportation choices and timing flexibility. The system may maintain separate probability fields for weekdays and weekends, or may generate more granular probability fields for specific days of the week that exhibit distinct arrival pattern characteristics.

The probability field may also be determined based at least in part on a month of the year, capturing seasonal variations in customer behavior, weather conditions, and traffic patterns that may affect arrival timing around pickup locations. Winter months may exhibit different arrival patterns compared to summer months due to weather-related factors that influence driving speeds, parking behaviors, and customer willingness to walk longer distances from parking areas to pickup locations. The system may maintain seasonal probability fields that account for weather-related variations in customer movement patterns and arrival timing characteristics.

Furthermore, the probability field may be determined based at least in part on a particular time trigger threshold, enabling the system to maintain different probability distributions that correspond to various event triggering requirements and operational timing constraints. A restaurant may require different probability fields for 30-second preparation triggers compared to 90-second preparation triggers, with each threshold potentially exhibiting different spatial patterns based on the specific timing requirements and preparation activities involved. The system may generate probability fields optimized for specific trigger thresholds, enabling accurate event triggering decisions that account for the particular operational requirements associated with different timing scenarios.

The probability field may be determined based at least in part on a speed of the user computing device, recognizing that customer movement speeds may significantly affect arrival timing and warrant separate probability field analysis. Customers traveling at higher speeds may exhibit different spatial approach patterns and arrival timing characteristics compared to customers moving at slower speeds, potentially due to different transportation modalities, traffic conditions, or route selections that affect movement behaviors. The system may analyze speed data collected from user computing devices to categorize customers into different speed ranges and maintain separate probability fields that account for the distinct arrival patterns associated with different movement speeds.

Additionally, the probability field may be determined based at least in part on a transport modality associated with the user computing device, accounting for the fundamental differences in spatial approach patterns that result from different transportation methods. Customers arriving by car may exhibit approach patterns concentrated around parking areas and vehicular access points, while pedestrian customers may approach from public transportation stops, nearby businesses, or residential areas with different spatial distributions. The system may maintain separate probability fields for different transportation modalities, such as driving, walking, biking, or public transportation, enabling arrival predictions that account for the distinct movement characteristics and spatial patterns associated with each transportation method.

In some instances, the method may include receiving location data of the user computing device based on a configurable parameter, wherein the configurable parameter is based on a distance of the user computing device to the virtual boundary. This distance-based configuration enables the system to optimize location data collection frequency and accuracy based on the proximity of customers to pickup locations, providing more detailed spatial information when precision is most critical for event triggering decisions while managing communication bandwidth and battery consumption when customers are at greater distances where precise positioning is less critical.

The configurable parameter may adjust the frequency of location data requests based on the distance between the user computing device and the virtual boundary, with the system requesting more frequent location updates as customers approach closer to pickup locations. When customers are at distances greater than 1000 meters from the virtual boundary, the system may request location updates every 10 seconds to monitor general approach progress while minimizing communication overhead. As customers approach within 500 meters of the virtual boundary, the system may increase the update frequency to every 5 seconds to capture more detailed movement patterns during the intermediate approach phase.

When customers reach distances within 200 meters of the virtual boundary, the system may further increase the location update frequency to every 2 seconds to capture precise movement patterns during the critical final approach phase where accurate positioning becomes most important for event triggering decisions. This dynamic frequency adjustment enables the system to optimize the balance between spatial resolution and system resource utilization, providing detailed location tracking when precision is most needed while managing communication bandwidth and mobile device battery consumption during less critical phases of the customer approach process.

The configurable parameter may also adjust the accuracy requirements for location data based on the distance to the virtual boundary, requesting higher precision GPS readings when customers are closer to pickup locations and accepting lower precision readings when customers are at greater distances. This accuracy-based configuration enables the system to optimize location data quality for event triggering decisions while managing the computational and power consumption requirements associated with high-precision location determination on mobile devices.

In some examples, the probability field may represent a heat map that provides a visual representation of the spatial probability distribution around pickup locations. The heat map comprises a plurality of pixels, where each pixel of the heat map represents the discretized location in the environment. This pixel-based representation enables efficient storage and retrieval of probability values through coordinate transformation and image-based lookup operations, allowing the system to rapidly translate customer location coordinates into pixel coordinates within the stored heat map for immediate access to corresponding probability values.

The heat map representation may utilize color coding or intensity variations to indicate different probability values across the spatial domain, with darker or more intense regions representing higher probability values and lighter regions representing lower probability values. For example, red or dark regions within the heat map may indicate spatial positions where historical data demonstrates high likelihood of customer arrival within the specified time threshold, while blue or light regions may indicate positions where customers historically required longer times to reach the pickup location. This visual representation enables intuitive interpretation of spatial probability patterns while providing the computational efficiency benefits of image-based data storage and retrieval.

Each pixel within the heat map corresponds to a specific discretized location within the spatial grid framework established around the pickup location, enabling precise mapping between continuous geographic coordinates and discrete probability values. The pixel resolution of the heat map may be configured to match the discretized grid resolution used for probability field generation, such as 5-meter grid cells, ensuring consistent spatial representation between the data collection, processing, and storage components of the system. The pixel-based representation enables the system to store comprehensive probability distributions as standard image formats that support efficient spatial queries and rapid probability retrievals during real-time event triggering evaluations.

The heat map storage format may utilize various image file formats or specialized data structures that optimize memory usage and access speed for spatial probability queries. Standard image formats such as PNG or JPEG may provide compatibility with existing image processing libraries and visualization tools, while specialized formats may offer enhanced precision for probability value storage and retrieval. The system may implement coordinate transformation algorithms that convert latitude and longitude coordinates into pixel coordinates within the stored heat map, enabling immediate access to probability values by accessing specific pixel locations within the image data structure.

With continued reference to FIG. 8, the additional method features may be integrated into the comprehensive process for probabilistic event triggering to enhance the system's adaptability and accuracy across various operational scenarios. The time of arrival data generation, Bayesian updating capabilities, contextual probability field selection, distance-based location data configuration, and heat map representation features work together to provide a robust and flexible framework for event triggering that can adapt to changing conditions while maintaining high accuracy in arrival predictions and operational coordination.

### EXAMPLE CLAUSES

A: A system comprising: one or more processors; and one or more non-transitory computer-readable media storing computer executable instructions that, when executed, cause the one or more processors to perform operations comprising: receiving map data representing a plurality of polygonal areas proximate a store; receiving a pickup order associated with a requesting entity, the pickup order indicating at least one good or service and a pickup location intent; associating the pickup order with a user computing device associated with a pickup entity; receiving location data from the user computing device; determining additional data associated with at least one of the user computing device or the store; inputting the pickup order, the location data, and the additional data into a machine-learning model trained to determine a particular estimated time of arrival of an entity to a pickup location of the store; receiving, from the machine-learning model and based at least in part on the pickup order, the location data, and the additional data, an estimated time of arrival of the pickup entity to a polygonal area associated with the pickup location intent; and sending, to a computing device associated with the store, the estimated time of arrival of the pickup entity to arrive at the polygonal area.

B: The system of paragraph A, wherein the polygonal area represents at least one of: a premises boundary associated with the store; a location of a drive-through associated with the store; a location of a curbside-pickup location associated with the store; a location of a parking lot associated with the store; or a physical location within the store.

C: The system of paragraph A or B, wherein the machine-learning model is trained based at least in part on ground truth data representing actual travel times between a first location of the user computing device and a second location associated with the store and a ground truth intent representing a declared region to arrive at the store.

D: The system of any of paragraphs A-C, the operations further comprising receiving, from the machine-learning model, confidence data associated with the estimated time of arrival.

E: The system of any of paragraphs A-D, wherein the additional data includes at least one of: a time of day the estimated time of arrival is determined; a day of a month the estimated time of arrival is determined; a day of a year the estimated time of arrival is determined; a minute of an hour the estimated time of arrival is determined; a weather pattern; order volume associated with the store; a number of customers associated with a location of the store; wait time associated with the store; order throughput data associated with the store; or a direction the requesting entity is relative to the store.

F: The system of any of paragraphs A-E, wherein the location data is first location data at a first time and the estimated time of arrival is a first estimated time of arrival determined at a first time, the operations further comprising: receiving, at a second time after the first time, second location data from the user computing device; inputting, based on receiving the second location data from the user computing device, the pickup order, the second location data, and the additional data into the machine-learning model; receiving, from the machine-learning model and based at least in part on the pickup order, the second location data, and the additional data, a second estimated time of arrival of the pickup entity to the polygonal area associated with the pickup location intent; and sending, to a computing device associated with the store, the second estimated time of arrival of the pickup entity to arrive at the polygonal area.

G: The system of any of paragraphs A-F, wherein the machine-learning model includes at least one of a random decision forest model or a deep neural network.

H: A method, implemented at least in part by one or more computing devices, the method comprising: receiving, from a merchant associated with a store, map data representing a polygonal area proximate the store; receiving a pickup order associated with a customer, the pickup order indicating at least one good or service and a pickup location intent; associating the pickup order with a user computing device associated with the customer; receiving location data from the user computing device; determining additional data associated with the user computing device; inputting pickup order, the location data, and the additional data into a machine-learning model trained to determine a particular estimated time of arrival of a customer to a location of the store; receiving, from the machine-learning model and based at least in part on the pickup order, the location data, and the additional data, an estimated time of arrival of the customer to the polygonal area associated with the pickup location intent; and sending, to a computing device associated with the store, the estimated time of arrival of the customer to arrive at the polygonal area.

I: The method of paragraph H, wherein the polygonal area represents at least one of: a premises boundary associated with the store; a location of a drive-through associated with the store; a location of a curbside-pickup location associated with the store; a location of a parking lot associated with the store; or a physical location within the store.

J: The method of paragraph H or I, wherein the machine-learning model is trained based at least in part on ground truth data representing actual travel times between a first location of the user computing device and a second location associated with the store and a ground truth intent representing a declared region to arrive at the store.

K: The method of any of paragraphs H-J, further comprising receiving, from the machine-learning model, confidence data associated with the estimate time of arrival.

L: The method of any of paragraphs H-K, wherein the additional data includes at least one of: a time of day the estimated time of arrival is determined; a day of a month the estimated time of arrival is determined; a day of a year the estimated time of arrival is determined; a minute of an hour the estimated time of arrival is determined; a weather pattern; order volume associated with the store; a number of customers associated with a location of the store; wait time associated with the store; order throughput data associated with the store; or a direction the customer is relative to the store.

M: The method of any of paragraphs H-L, wherein the location data is first location data at a first time and the estimated time of arrival is a first estimated time of arrival determined at a first time, further comprising: receiving, at a second time after the first time, second location data from the user computing device; inputting, based on receiving the second location data from the user computing device, the pickup order, the second location data, and the additional data into the machine-learning model; receiving, from the machine-learning model and based at least in part on the pickup order, the second location data, and the additional data, a second estimated time of arrival of the customer to the polygonal area associated with the pickup location intent; and sending, to a computing device associated with the store, the second estimated time of arrival of the customer to arrive at the polygonal area.

N: The method of any of paragraphs H-M, wherein the machine-learning model includes at least one of a random decision forest model or a deep neural network.

O: One or more non-transitory computer-readable media storing computer executable instructions that, when executed, cause one or more processors to perform operations comprising: receiving, from a merchant associated with a store, map data representing a polygonal area proximate the store; receiving a pickup order associated with a customer, the pickup order indicating at least one good or service and a pickup location intent; associating the pickup order with a user computing device associated with the customer; receiving location data from the user computing device; determining additional data associated with the user computing device; inputting pickup order, the location data, and the additional data into a machine-learning model trained to determine a particular estimated time of arrival of a customer to a location of the store; receiving, from the machine-learning model and based at least in part on the pickup order, the location data, and the additional data, an estimated time of arrival of the customer to the polygonal area associated with the pickup location intent; and sending, to a computing device associated with the store, the estimated time of arrival of the customer to arrive at the polygonal area.

P: The one or more non-transitory computer-readable media of paragraph O, wherein the polygonal area represents at least one of: a premises boundary associated with the store; a location of a drive-through associated with the store; a location of a curbside-pickup location associated with the store; a location of a parking lot associated with the store; or a physical location within the store.

Q: The one or more non-transitory computer-readable media of paragraph O or P, wherein the machine-learning model is trained based at least in part on ground truth data representing actual travel times between a first location of the user computing device and a second location associated with the store and a ground truth intent representing a declared region to arrive at the store.

R: The one or more non-transitory computer-readable media of any of paragraphs O-Q, the operations further comprising receiving, from the machine-learning model, confidence data associated with the estimated time of arrival.

S: The one or more non-transitory computer-readable media of any of paragraphs O-R, wherein the additional data includes at least one of: a time of day the estimated time of arrival is determined; a day of a month the estimated time of arrival is determined; a day of a year the estimated time of arrival is determined; a minute of an hour the estimated time of arrival is determined; a weather pattern; order volume associated with the store; a number of customers associated with a location of the store; wait time associated with the store; order throughput data associated with the store; or a direction the customer is relative to the store.

T: The one or more non-transitory computer-readable media of any of paragraphs O-S, wherein the location data is first location data at a first time and the estimated time of arrival is a first estimated time of arrival determined at a first time, the operations further comprising: receiving, at a second time after the first time, second location data from the user computing device; inputting, based on receiving the second location data from the user computing device, the pickup order, the second location data, and the additional data into the machine-learning model; receiving, from the machine-learning model and based at least in part on the pickup order, the second location data, and the additional data, a second estimated time of arrival of the customer to the polygonal area associated with the pickup location intent; and sending, to a computing device associated with the store, the second estimated time of arrival of the customer to arrive at the polygonal area.

U: A method comprising: receiving first location data from a user computing device, the first location data representing locations of the user computing device as the user computing device approaches a pickup location; receiving data indicating when the user computing device entered a virtual boundary associated with the pickup location; determining, based on the first location data, a location of the user computing device when the user computing device was a particular time period away from the user computing device entering the virtual boundary; associating the location with a discretized location of a map of an environment proximate the pickup location; applying a blurring function to the map to generate a probability field, wherein a probability of the probability field indicates a probability of a computing device at a particular location entering the virtual boundary within the particular time period; using the probability field to determine a probability of arriving at the pickup location within the particular time period; and triggering an action at the pickup location based on the probability meeting or exceeding a threshold probability.

V: The method of paragraph U, wherein the probability field for the pickup location is generated based on time of arrival data associated with the pickup location.

W: The method of paragraph U or V, wherein the blurring function comprises a Gaussian blur function.

X: The method of any of paragraphs U-W, further comprising: receiving additional location data representing additional locations and arrival times of other user computing devices associated with the pickup location; and generating an updated probability field based at least in part on the probability field, the additional location data, and a Bayesian algorithm.

Y: The method of any of paragraphs U-X, wherein the probability field is one of a plurality of probability fields, and wherein the probability field is determined based at least in part on at least one of: a time of day; a day of the week; a month of the year; a particular time trigger threshold; a speed of the user computing device; or a transport modality associated with the user computing device.

Z: The method of any of paragraphs U-Y, further comprising: determining the probability based on a first probability associated with a first discrete region of the probability field and a second probability associated with a second discrete region of the probability field that is different than the first discrete region.

AA: The method of any of paragraphs U-Z, further comprising: receiving location data of the user computing device based on a configurable parameter, wherein the configurable parameter is based on a distance of the user computing device to the virtual boundary.

AB: The method of any of paragraphs U-AA, wherein: the probability field represents a heat map; the heat map comprises a plurality of pixels; and a pixel of the heat map represents the discretized location in the environment.

AC: The method of any of paragraphs U-AB, wherein using the probability field to determine the probability of arriving at the pickup location comprises receiving location data from a pickup entity, wherein the pickup entity delivers an order to a customer.

AD: A system comprising: one or more processors; and one or more non-transitory computer-readable media storing computer executable instructions that, when executed, cause the one or more processors to perform operations comprising: receiving first location data from a user computing device, the first location data representing locations of the user computing device as the user computing device approaches a pickup location; receiving data indicating when the user computing device entered a virtual boundary associated with the pickup location; determining, based on the first location data, a location of the user computing device when the user computing device was a particular time period away from the user computing device entering the virtual boundary; associating the location with a discretized location of a map of an environment proximate the pickup location; applying a blurring function to the map to generate a probability field, wherein a probability of the probability field indicates a probability of a computing device at a particular location entering the virtual boundary within the particular time period; using the probability field to determine a probability of arriving at the pickup location within the particular time period; and triggering an action at the pickup location based on the probability meeting or exceeding a threshold probability.

AE: The system of paragraph AD, wherein the probability field for the pickup location is generated based on time of arrival data associated with the pickup location.

AF: The system of paragraph AD or AE, the operations further comprising: receiving additional location data representing additional locations and arrival times of other user computing devices associated with the pickup location; and generating an updated probability field based at least in part on the probability field, the additional location data, and a Bayesian algorithm.

AG: The system of any of paragraphs AD-AF, wherein the probability field is one of a plurality of probability fields, and wherein the probability field is determined based at least in part on at least one of: a time of day; a day of the week; a month of the year; a particular time trigger threshold; a speed of the user computing device; or a transport modality associated with the user computing device.

AH: The system of any of paragraphs AD-AG, the operations further comprising: receiving location data of the user computing device based on a configurable parameter, wherein the configurable parameter is based on a distance of the user computing device to the virtual boundary.

AI: The system of any of paragraphs AD-AH, wherein: the probability field represents a heat map; the heat map comprises a plurality of pixels; and a pixel of the heat map represents the discretized location in the environment.

AJ: The system of any of paragraphs AD-AI, wherein using the probability field to determine the probability of arriving at the pickup location comprises receiving location data from a pickup entity, wherein the pickup entity delivers an order to a customer.

AK: One or more non-transitory computer-readable media storing computer executable instructions that, when executed, cause one or more processors to perform operations comprising: receiving first location data from a user computing device, the first location data representing locations of the user computing device as the user computing device approaches a pickup location; receiving data indicating when the user computing device entered a virtual boundary associated with the pickup location; determining, based on the first location data, a location of the user computing device when the user computing device was a particular time period away from the user computing device entering the virtual boundary; associating the location with a discretized location of a map of an environment proximate the pickup location; applying a blurring function to the map to generate a probability field, wherein a probability of the probability field indicates a probability of a computing device at a particular location entering the virtual boundary within the particular time period; using the probability field to determine a probability of arriving at the pickup location within the particular time period; and triggering an action at the pickup location based on the probability meeting or exceeding a threshold probability.

AL: The one or more non-transitory computer-readable media of paragraph AK, wherein the probability field for the pickup location is generated based on time of arrival data associated with the pickup location.

AM: The one or more non-transitory computer-readable media of paragraph AK or AL, the operations further comprising: receiving additional location data representing additional locations and arrival times of other user computing devices associated with the pickup location; and generating an updated probability field based at least in part on the probability field, the additional location data, and a Bayesian algorithm.

AN: The one or more non-transitory computer-readable media of any of paragraphs AK-AM, the operations further comprising: receiving location data of the user computing device based on a configurable parameter, wherein the configurable parameter is based on a distance of the user computing device to the virtual boundary.

AO: A method comprising: receiving first location data from a user computing device, the first location data representing locations of the user computing device as the user computing device approaches a pickup location; receiving data indicating when the user computing device entered a virtual boundary associated with the pickup location; determining, based on the first location data, a location of the user computing device when the user computing device was a particular time period away from the user computing device entering the virtual boundary; associating the location with a discretized location of a map of an environment proximate the pickup location; applying a blurring function to the map to generate a probability field, wherein a probability of the probability field indicates a probability of a computing device at a particular location entering the virtual boundary within the particular time period; using the probability field to determine a probability of arriving at the pickup location within the particular time period; and triggering an action at the pickup location based on the probability meeting or exceeding a threshold probability.

AP: The method of paragraph AO, wherein the probability field for the pickup location is generated based on time of arrival data associated with the pickup location.

AQ: The method of paragraph AO or AP, wherein the blurring function comprises a Gaussian blur function.

AR: The method of paragraph AQ, wherein the Gaussian blur function utilizes configurable parameters including kernel size and standard deviation that are tuned for accuracy optimization based on site-specific characteristics.

AS: The method of any of paragraphs AO-AR, further comprising: receiving additional location data representing additional locations and arrival times of other user computing devices associated with the pickup location; and generating an updated probability field based at least in part on the probability field, the additional location data, and a Bayesian algorithm.

AT: The method of paragraph AS, wherein the Bayesian algorithm treats the probability field as a prior distribution and combines the prior distribution with the additional location data to generate an updated posterior distribution.

AU: The method of any of paragraphs AO-AT, wherein the probability field is one of a plurality of probability fields, and wherein the probability field is determined based at least in part on at least one of: a time of day; a day of the week; a month of the year; a particular time trigger threshold; a speed of the user computing device; or a transport modality associated with the user computing device.

AV: The method of any of paragraphs AO-AU, further comprising determining the probability based on a first probability associated with a first discrete region of the probability field and a second probability associated with a second discrete region of the probability field that is different than the first discrete region.

AW: The method of any of paragraphs AO-AV, further comprising receiving location data of the user computing device based on a configurable parameter, wherein the configurable parameter is based on a distance of the user computing device to the virtual boundary.

AX: The method of any of paragraphs AO-AW, wherein: the probability field represents a heat map; the heat map comprises a plurality of pixels; and each pixel of the heat map represents the discretized location in the environment.

AY: A system comprising: one or more processors; and one or more non-transitory computer-readable media storing computer executable instructions that, when executed, cause the one or more processors to perform operations comprising: receiving location data from a user computing device approaching a pickup location; determining a discretized location on a spatial grid based on the location data; generating a probability field by applying a filtering function to historical location data associated with the pickup location, wherein the probability field indicates spatial probabilities of arrival within a specified time threshold; evaluating the discretized location against the probability field to determine an arrival probability; and initiating an operational action at the pickup location when the arrival probability exceeds a predetermined threshold.

AZ: The system of paragraph AY, wherein the filtering function comprises a Gaussian blur function that applies a mathematical kernel to discrete location observations to create smooth probability transitions across the spatial grid.

BA: The system of paragraph AZ, wherein the Gaussian blur function utilizes configurable parameters including kernel size and standard deviation that are tuned for accuracy optimization based on site-specific characteristics and historical performance data.

BB: The system of any of paragraphs AY-BA, wherein the operations further comprise: receiving additional location data representing additional locations and arrival times of other user computing devices associated with the pickup location; and generating an updated probability field based at least in part on the probability field, the additional location data, and a Bayesian algorithm.

BC: The system of paragraph BB, wherein the Bayesian algorithm treats the probability field as a prior distribution representing current beliefs about spatial arrival patterns and combines the prior distribution with the additional location data as new evidence to generate an updated posterior distribution.

BD: A method comprising: collecting historical location data from a plurality of user computing devices approaching a pickup location; processing the historical location data to identify spatial positions associated with predetermined time thresholds before arrival at the pickup location; mapping the spatial positions onto a discretized grid overlaying an area proximate the pickup location; applying a mathematical function to generate a spatial probability distribution across the discretized grid; receiving current location data from a user computing device; determining a probability of arrival within a specified time period based on the current location data and the spatial probability distribution; and triggering a preparation activity at the pickup location when the probability of arrival meets a trigger criterion.

BE: The method of paragraph BD, wherein the mathematical function comprises a Gaussian blur function that applies a mathematical kernel to the spatial positions to create smooth probability transitions across the discretized grid.

BF: The method of paragraph BE, wherein the Gaussian blur function utilizes configurable parameters including kernel size and standard deviation that are tuned for accuracy optimization based on site-specific characteristics and historical performance data.

BG: The method of any of paragraphs BD-BF, further comprising: receiving additional historical location data from other user computing devices; and updating the spatial probability distribution using a Bayesian algorithm that treats the existing spatial probability distribution as a prior distribution and combines it with the additional historical location data to generate an updated posterior distribution.

BH: The method of paragraph BG, wherein the Bayesian algorithm enables continuous learning by automatically incorporating new location observations while preserving accumulated knowledge from the historical location data without requiring complete reprocessing of the historical location data.

While the example clauses described above are described with respect to one particular implementation, it should be understood that, in the context of this document, the content of the example clauses can also be implemented via a method, device, system, computer-readable medium, and/or another implementation. Additionally, any of examples A-BH may be implemented alone or in combination with any other one or more of the examples A-BH.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving first location data from a user computing device, the first location data representing locations of the user computing device as the user computing device approaches a pickup location;
receiving data indicating when the user computing device entered a virtual boundary associated with the pickup location;
determining, based on the first location data, a location of the user computing device when the user computing device was a particular time period away from the user computing device entering the virtual boundary;
associating the location with a discretized location of a map of an environment proximate the pickup location;
applying a blurring function to the map to generate a probability field, wherein a probability of the probability field indicates a probability of a computing device at a particular location entering the virtual boundary within the particular time period;
using the probability field to determine a probability of arriving at the pickup location within the particular time period; and
triggering an action at the pickup location based on the probability meeting or exceeding a threshold probability.

2. The method of claim 1, wherein the probability field for the pickup location is generated based on time of arrival data associated with the pickup location.

3. The method of claim 1, wherein the blurring function comprises a Gaussian blur function.

4. The method of claim 1, further comprising:
receiving additional location data representing additional locations and arrival times of other user computing devices associated with the pickup location; and
generating an updated probability field based at least in part on the probability field, the additional location data, and a Bayesian algorithm.

5. The method of claim 1, wherein the probability field is one of a plurality of probability fields, and wherein the probability field is determined based at least in part on at least one of:
a time of day;
a day of the week;
a month of the year;
a particular time trigger threshold;
a speed of the user computing device; or
a transport modality associated with the user computing device.

6. The method of claim 1, further comprising:
determining the probability based on a first probability associated with a first discrete region of the probability field and a second probability associated with a second discrete region of the probability field that is different than the first discrete region.

7. The method of claim 1, further comprising:
receiving location data of the user computing device based on a configurable parameter, wherein the configurable parameter is based on a distance of the user computing device to the virtual boundary.

8. The method of claim 1, wherein:
the probability field represents a heat map;
the heat map comprises a plurality of pixels; and
a pixel of the heat map represents the discretized location in the environment.

9. The method of claim 1, wherein using the probability field to determine the probability of arriving at the pickup location comprises receiving location data from a pickup entity, wherein the pickup entity delivers an order to a customer.

10. A system comprising:
one or more processors; and
one or more non-transitory computer-readable media storing computer executable instructions that, when executed, cause the one or more processors to perform operations comprising:
receiving first location data from a user computing device, the first location data representing locations of the user computing device as the user computing device approaches a pickup location;
receiving data indicating when the user computing device entered a virtual boundary associated with the pickup location;
determining, based on the first location data, a location of the user computing device when the user computing device was a particular time period away from the user computing device entering the virtual boundary;
associating the location with a discretized location of a map of an environment proximate the pickup location;
applying a blurring function to the map to generate a probability field, wherein a probability of the probability field indicates a probability of a computing device at a particular location entering the virtual boundary within the particular time period;
using the probability field to determine a probability of arriving at the pickup location within the particular time period; and
triggering an action at the pickup location based on the probability meeting or exceeding a threshold probability.

11. The system of claim 10, wherein the probability field for the pickup location is generated based on time of arrival data associated with the pickup location.

12. The system of claim 10, the operations further comprising:
receiving additional location data representing additional locations and arrival times of other user computing devices associated with the pickup location; and
generating an updated probability field based at least in part on the probability field, the additional location data, and a Bayesian algorithm.

13. The system of claim 10, wherein the probability field is one of a plurality of probability fields, and wherein the probability field is determined based at least in part on at least one of:
a time of day;
a day of the week;
a month of the year;
a particular time trigger threshold;
a speed of the user computing device; or
a transport modality associated with the user computing device.

14. The system of claim 10, the operations further comprising:
receiving location data of the user computing device based on a configurable parameter, wherein the configurable parameter is based on a distance of the user computing device to the virtual boundary.

15. The system of claim 10, wherein:
the probability field represents a heat map;
the heat map comprises a plurality of pixels; and
a pixel of the heat map represents the discretized location in the environment.

16. The system of claim 10, wherein using the probability field to determine the probability of arriving at the pickup location comprises receiving location data from a pickup entity, wherein the pickup entity delivers an order to a customer.

17. One or more non-transitory computer-readable media storing computer executable instructions that, when executed, cause one or more processors to perform operations comprising:
receiving first location data from a user computing device, the first location data representing locations of the user computing device as the user computing device approaches a pickup location;
receiving data indicating when the user computing device entered a virtual boundary associated with the pickup location;
determining, based on the first location data, a location of the user computing device when the user computing device was a particular time period away from the user computing device entering the virtual boundary;
associating the location with a discretized location of a map of an environment proximate the pickup location;
applying a blurring function to the map to generate a probability field, wherein a probability of the probability field indicates a probability of a computing device at a particular location entering the virtual boundary within the particular time period;
using the probability field to determine a probability of arriving at the pickup location within the particular time period; and
triggering an action at the pickup location based on the probability meeting or exceeding a threshold probability.

18. The one or more non-transitory computer-readable media of claim 17, wherein the probability field for the pickup location is generated based on time of arrival data associated with the pickup location.

19. The one or more non-transitory computer-readable media of claim 17, the operations further comprising:
receiving additional location data representing additional locations and arrival times of other user computing devices associated with the pickup location; and
generating an updated probability field based at least in part on the probability field, the additional location data, and a Bayesian algorithm.

20. The one or more non-transitory computer-readable media of claim 17, the operations further comprising:
receiving location data of the user computing device based on a configurable parameter, wherein the configurable parameter is based on a distance of the user computing device to the virtual boundary.
